(19) United States
(12) Patent Application Publication
(10) Pub. No.: US 2025/0084493 A1
(43) Pub. Date: Mar. 13, 2025

(54) APPARATUS TO MODIFY SIMULATED MOVING BED FOR CONTINUOUS SEPARATION OF GLUCOSE AND FRUCTOSE

(71) Applicant: Hsien-Chih MA, Morris Plains, NJ (US)

(72) Inventor: Hsien-Chih MA, Morris Plains, NJ (US)

(21) Appl. No.: 18/243,560

(22) Filed: Sep. 7, 2023

(51) Int. Cl. C13K 1/00; B01D 15/18; B01D 15/36; B01D 15/42; C13K 11/00

(52) U.S. Cl. CPC C13K 1/00; B01D 15/1885; B01D 15/362; B01D 15/426; C13K 11/00

(57) ABSTRACT

An apparatus disclosed herein is for implementing new mass transfer method to eliminate displacement zone via maintaining installed resin in column in semi-dry status for superior mass transfer between two phases. Through implementing following methods comprising new mass transfer method, differential set-up and via single stage recycle procedures integrating with modules, apparatus herein disclosed is operated in a contained loop comprising multiple modules connected in sequence and yet function independently to simultaneously feeding raw solution containing glucose and fructose, inputting eluent water, retrieving raffinate glucose and product fructose, and other recycling mixtures to enhance concentration of separated fractions and capable of continuous separation of glucose and fructose feed solution into 100% yield of respective pure component. Disclosed apparatus cutbacks nearly 40% of resin stock compared under same feed throughput with traditional simultaneous moving bed process that has separation of 88% recovery of 90% fructose purity in product stream.

### BACKGROUND OF THE INVENTION

### Prior Art

This is a continuation of U.S. Pat. No. 6,258,176 B1, date of patent granted on Jul. 10, 2001. This disclosure relates to a process employed on a preferred apparatus, but not limited to apparatus design alternatives for producing high fructose corn syrup (abbreviated as HFCS), for a homogeneous aqueous feed solution, mixture of glucose and fructose obtained from the isomerization tower. Said preferred apparatus employs as a subsequent unit operation for separating components of said sugar mixtures alike. More broadly, this preferred apparatus and process is employed for the continuous separation of the glucose and fructose solution mixtures to simultaneously retrieve various grades of glucose and fructose solution mixture and to obtain the separated fractions of elevated concentration level. Yet, this said apparatus compared with traditional chromatographic process, it has its ultimate object to lower production cost, to consume much less resin inventory, eluent water, to gain the ultimate purity, and to yield of much higher concentration of glucose and fructose component.

### The Description of Prior Art

It is known that the process currently been used for separating the solution mixtures of glucose and fructose is by inputting the feed solution through a cation exchange chromatographic column then by introducing the de-ionized water to elute the dissolved components of said feed solution through which the separation is obtained. As taught by U.S. Pat. Nos. 3,044,904, 4,472,203, 4,395,292, Japanese Pat. No. 24,807 of 1970, and many other unlisted disclosures, without exception, single fixed bed chromatography is the fundamentals of mechanical device along with resembling mass transfer mechanism been used in those publications. The separation is carried out within a typical long and tall column packed with stationary resin. They are all fallen into same category of mass transfer phenomena that occurs within so called the mass transfer zone in which the eluent water is in conjunction with feed. As such zone is being transported by continuous introducing the eluent water pushing behind the feed solution, the fructose is retained by the resin to a greater degree than glucose through which the separation is achieved. At any instance of chromatographic operation, the contributed resin for separation is only when such zone passed by and the remaining are idle. Note that the so-called the displacement zone is always existed as eluent water pushing off previous feed introducing through resin bed to proceed separation. As various methods and processes being developed upon said mass transfer mechanism in chromatography, the column process has been long recognized and implemented as standard equipment that inherent with shortcomings. Such fundamental mass transfer mechanism has not been further improved through using same resin and eluent in much less inventory and yet gaining better separation. Those imperfections are multifaceted coexisted and affecting one another, which are briefly illustrated as following:
Inefficient usage of resin, the mass transfer proceeded only at the very front of mass transfer zone, the resin before and after such zone are idle;
Due to existence of displacement zone to create excess dilution and to increase cycle time thus enhancing inefficient usage of resin;
Engineering drawbacks of smearing component profile in column process; listed as following;
   1. Flow dynamics: axial dispersion and diffusion effects are important in affecting separation quality, include back mixing of column end effects.
   2. Column geometry: in and out, column end-effects includes dead volume.
   3. Loading limitation: to avoid peak broadening, overlapping, and tailing due flow-dynamics.
Require long cycle time to further weaken economic consumption of resin and eluent, to intensify said engineering drawbacks; and
High-pressure drop and difficulty in maintenance.

An improved simulated moving bed process, abbreviated as SMB, is taught in both Japanese Provisional Patent Publication No. 26336 of 1978 in which zeolite is used as resin and Japanese Provisional Patent Publication No. 88355 of 1978 in which a cation exchange resin is used. In those later becomes well accepted as so called “Corn Sweetener” industrial process for glucose and fructose separation. The process compromises multiple columns connected in series, each column has its distributors to allow fluid to flow into and out of such column. Actually, each column in such series connection represents a particular mass-transfer task compared to a long column to carry out all tasks in sequence. At a setting time interval, all points of feed loading, eluent water introducing, product and by-product withdrawals are shifted simultaneously purposely for cutting down resin consumption. Unlike rapid virtue of high ion mobility and electrical actions in water ion exchange reactions, the glucose and fructose separations are very slow. These sugars are non-electrolytes and their separation is governed by a very narrow difference interaction between sugar components and resin. An additional factor in affecting such interaction difference is water content within the mobile phase. It eliminates such interaction to minimal when too much water exists due sugars are very soluble in water. Despite various difficult natures, the general practice of SMB process operates at a flow rate of 0.8 to 1.0 bed-volume per hour for achieving separation based on small interaction difference between sugar components and resin. In the other words, the process takes 1 to 1.25 hours to complete a separation cycle. Nevertheless, the loading limitation is set at 0.05 to 0.1 feed rate to resin bed volume ratio as the operation guideline to obtain acceptable separation quality versus operation efficiency. For example, a feed input rate of 200 gallons per minute will consume 2000 gallons of resin per minute based on 0.1 ratio. For a 1 to 1.25 hours cycle process, it will consume 120,000 to 150,000 gallons of resin. In viewpoints of excess resin being used in chromatographic process, excess eluent has to be coped in order to push off the separated fractions. It surprisingly consumes about two times of eluent water as feed input rate. Overall speaking, the SMB process is far superior to a single fixed bed process in aspects of resin consumption, operation efficiency, product yield and quality. Therefore, it has been overwhelmingly adopted as the standard industrial process ever since first introduced. However, this process is limited by using chromatography with attempting in manipulating the column configuration and optimization in fluid distribution, in which the process yet inherits the aforementioned native drawbacks of column chromatography.

### SUMMARY OF THE INVENTION

In view of the foregoing shortcomings in applying chromatography for glucose and fructose separation, it raises an essentiality to fundamentally renovate the mass transfer mechanism in chromatography. Said resin is made of by an alkaline earth metal base strongly acidic cation exchanger resin. Concisely illustration of objects of this invention is accomplished by providing a continuous ion exchange process to simultaneously separate the feed solution into pure form of liquid glucose and fructose with 100% yield through a cutback of resin inventory, to reduce eluent water consumption, and to benefit elevating product and by-product dry solid (abbreviated as DS) concentration. The process is completed by the integration of a new mass transfer method, a differential set-up between resin and liquid phases, an operation protocols, and an apparatus to implement all above indicated methods.

It is, therefore, a fundamental object of this invention to initiate a new mass transfer method different from that observed in chromatography to eliminate the displacement zone and further utilize the void volume available for prompt mass transfer proceeding. Such said method in general is composed of at least one of following procedures.
1. Retain solid phase material in a bundled group of predetermined quantity of columns, each individual column having an inlet on one side and an outlet on another side with bottom meshed filter to contain said material from being drained. Bundled group of columns perform as partially fluidized bed as a whole unit is named as cell hereinafter.
2. Intermittently and simultaneously deliver predetermined amounts of liquid material to each of said cells, either promoting adsorption of dissolved components onto said material or elution of adsorbed components from said material.
3. Intermittently and simultaneously supply broad range pressurized inert gas to the group of cells on the one side following each delivery of a liquid to force prompt draining of delivered liquid through said material contained in each cell to complete expected mass transfer equilibrium between two phases.
4. Maintain a vacuum on the other side of said group of cells to maintain said material in a semi-dry status.
5. Intermittently collecting most of treated solution from the bundled outlet of said group of cells.
6. Total time spent from step 2 to step 5 is defined as minimal time interval.

Apparatus herein disclosed installed with resin installed in SMB chromatography carries out such indicated methods. The apparatus is composed of plurality of modules connected in sequence to meet specific production target; this concept of construction among modules to satisfy production throughput requirement, operation smoothness, and maintenance flexibility as a whole apparatus will be illustrated further hereinafter.

Having a plurality of holding tanks, assigned for receiving particular liquid, arranged in an organized array in selected pattern as preferred set up, such group of holding tanks set inside a warm water circulation insulated jacket having a warm water inlet and warm water outlet to maintain whole plurality of holding tanks in a selected temperature range. Each holding tank of whole plurality has an inlet extended outside upward of said jacket to receive liquid and has an outlet extended outside downward of said jacket to discharge stored liquid to the following rotary union multiple valves module. This is defined as holding tanks module.

Above mentioned rotary union multiple valves module having a rotational circular multiple valves body driven by a Servo-motor rotate intermittently stepped at a predetermined equal angle. Said multiple valves body having a plurality of liquid inlet conduct installed at predetermined location to simultaneously and intermittently receiving dose of liquid transferred from particular holding tank of above said holding tanks module. This rotational valves body having an equal quantity of outlet conduct installed at corresponding location to precisely transmit said dose of liquid to next following module. At any time interval, all kinds of liquid stored in each said holding tanks module is delivered from particular tank and simultaneously transmitted via rotational multiple valves body to the next module.

Having a plurality of said cells arranged in preferred pattern. As previously said each cell compromises a plurality of columns, each column has a top side opening means for liquid input and bottom screen filter means for retaining said resin from been drained. All cells arranged in a similar organized array of said holding tanks module as preferred set up for easier organizing liquid flow from corresponding holding tank via said rotary union module. Such group of cells set inside a warm water circulation insulated jacket having a warm water inlet and warm water outlet to maintain whole plurality of cells in a selected temperature range. Each cell has a liquid inlet conduct extended outside upward of the water jacket to receive particular liquid delivered via upstream rotary union module from corresponding holding tank via a showerhead installed on top of plurality of columns. Each cell top has a pipe means for intermittently receiving supply of pressurized inert gas to force prompt draining of delivered liquid through said resin contained in each cell to complete expected mass transfer equilibrium between two phases. Each cell bottom is exposed to vacuum to maintain said resin in a semi-dry status, and to affiliate liquid draining via a liquid conduct into each underneath temporary liquid reservoir. Each bottom of cell has a liquid conduct extended outward insulated water jacket means for simultaneous transferring particular liquid in each underneath cell temporary liquid reservoir via downstream rotary union module to each corresponding holding tank in said holding tanks module to further continuously carry out new mass transfer method of separation between glucose and fructose solution mixture in following repeated manner.

Predetermined amount of all liquids, including feed solution, eluent water, and recycled streams from predetermined holding tank located in holding tanks module is intermittently and simultaneously delivered via upstream rotary union module via said showerhead installed inside of respective cell to sprinkle a wetted region of retained resin. Such delivered liquid is instantaneously settled and drained by said pressurized inert gas applied from top of all cells and vacuum exerted simultaneously from bottom of all cells to maintain resin at semi-dry status. The whole time, the drained liquid from respective cell is collected through each said temporary liquid reservoir located beneath each cell. The collected liquid flows via downstream rotary union and delivered into each corresponding holding tank in said holding tanks module. The whole time, the exit wet inert gas from bottom part of this apparatus is passing through an inert gas supply sub-module to condense the water mist and this sub-module will be illustrated later. Then, both upstream and downstream rotary union module advance further one predetermined rotation step by means of rotation mechanism before next dose of simultaneous liquid input. During steady stage operation, all cells in the apparatus perform repeatedly and simultaneously with liquid filling, liquid draining and collecting through all said modules connected in sequence means within every spent of said minimal time interval. This part is defined as separation module hereinafter.

Simultaneously exerting closed vacuum environment via a manifold conduct onto entire bottom part of said separation module means for prompt liquid draining and meanwhile extracting moisture enriched wet inert gas through a mist separation device to collect condensed water for recycle and convert wet inert gas to dry inert gas. Said dry inert gas exiting mist separator is combined with pressurized dry air and deployed through an inert gas generator to obtain fresh inert gas and to store in a steel tank vessel maintaining at preferred pressure level ready for deploying back to said separation module and each said holding tanks modules. There has an inline gas warmer installed to assure fresh dry inert gas maintained slightly higher than liquid temperature range prior intermittently and simultaneously entering said separation module via a manifold conduct. For supplying broad range pressurized inert gas to incorporate with aforesaid modules to affiliate liquid phase transmitting within disclosed apparatus. This part is defined as inert gas supply module that is sub-module integrated with said separation module.

It is an object of the invention to maximize the utilization of resin installed in each cell. The amount of resin installed in each cell is equivalent to resin of mass transfer zone (abbreviated as MTZ) in traditional chromatography. It means the resin installed in feed deployed zone is completely saturated with feed solution. In chromatography, this MTZ is the resin been saturated with feed in about 5 to 10% of bed volume and transported by eluent from one end to exit from other end of column.

More specifically, it is an object of the apparatus to employ differential set-up protocols among all kinds of solutions to simultaneously interact with retained resin in a cell to efficiently reduce cycle time compared with chromatography. Briefly characterized thereafter are methods for said protocols by obtaining a satisfactory separation result characteristic elution profile in time spent domain from said single column testing. Such elution profile represent a whole separation result of sugar solution and such single column is one of numerous columns bundled as group allocated within in a single cell. Creating said single column testing is performed through sequentially and intermittently delivering predetermined volume of said all liquids via means of said new mass transfer method. Breaking down obtained profile with each partial time required for respective solution is the time needed to spend for this particular zone. Divide each partial time by said minimal time interval to obtain the number of doses dropping for such zone. Then, divides the volume of such liquid by the number of doses to obtain the partial volume required for each dose. Further divides both said resin, which derived from complete saturation with feed solution, and partial volume of such liquid by a pre-selected number that corresponds to at least one cell in a group of cells at each zone to simultaneously receive the partial volume of such liquid for each cell in said group of cells. Sequentially allocate all cells with respective solution as the range of respective zone and allocated all zones into an endless format. Prepare predetermined volume of respective solution to store in respective holding tank in said holding tanks module for such liquid distribution. For simultaneous delivering of various fluids during each spent of said minimal time interval into respective zone during steady state operation in this disclosed apparatus, by which this apparatus transforms way of liquid flow observed in traditional chromatographic separation from parallel into vertical with mobile phase's flow direction in a differential format to maximize usage of installed resin during duration of each minimal time interval being spent.

It is a further object of this invention to establish single stage recycle protocols onto said apparatus to simultaneously proceed continuous separation and concentration enhancement of fractionated mixtures to cut down eluent water consumption. Said recycling protocols simultaneously input streams of feed solution and eluent water, and other recycled streams from predetermined holding tank into predetermined zone. Each zone is independent from each other and yet is communicating through each respective upstream and downstream holding tank. Consequently, this disclosure separates a feed stream continuously into two streams each in 100% yield of pure composition of glucose and fructose in feed; and a multiplicity of recycling streams in stable composition and concentration of glucose and fructose mixture. Scaling up for industrial production apparatus is to employ all above said modules via duplicating a single column test results in multiple differential set up to obtain ultimate separation efficiency.

### BRIEF DESCRIPTION OF THE DRAWINGS

The above and other objects, distinct features and merits of the present invention can be more readily explained from the following illustration, taken with drawings in which:

FIG. 1 is perspective view of preferred apparatus for the separation of said sugar mixtures illustrated in aforementioned modules connected in series for flow of all kind of liquids via an example of 24 cells in separation module;

FIG. 2 is perspective view of preferred inert gas supply module that is sub-module integrated with said separation module; and that is briefly shown on left side of FIG. 1;

FIG. 3 shows the concentration profile from a single cell testing as an example of 24-zones protocols in which the glucose, fructose, and oligosaccharide, abbreviated as oligos, are plotted as D.S. % vs. elution time, and wherein the pure glucose and fructose stream are recovered from a feed stream;

FIG. 4 is the schematic diagram for converting such elution profiles of FIG. 3 into a single-stage recycle process;

FIG. 5 is perspective view of FIG. 4 of single stage employed by the disclosed apparatus emphasizing for single stage recycle process for sugar solution separation arranged in endless format and further illustrating multiple separation module simultaneously operated in parallel exemplified in three of such module;

Figure-6 is the elution profiles of cycle 1 through cycle 4 via impulse input S-I at 0.25 of feed to bed volume ratio wherein the steady state is obtained at cycle 4;

FIG. 7 represents cycle 5, a continuation of steady state of six-zones cycle from said FIG. 6, wherein a raffinate stream and a product stream are retrieved simultaneously; and

FIG. 8 through FIG. 12 are the steady state elution profiles of six consecutive cycles constructed by addition of a raffinate zone and a product zone into a current cycle wherein the composition of said zones are predetermined from the retrieved raffinate and product stream of previous cycle; and wherein FIG. 8 stands for a 9 zones profiles, FIG. 9 stands for 11 zones profile, FIG. 10 stands for 13 zones profiles, FIG. 11 stands for 15 zones wherein a product stream is retrieved from zone 13 for elevated concentration, FIG. 12 stands for 17 zones wherein a nearly pure product stream is retrieved from zone 15 for elevated concentration. This elution profile demonstrated in FIG. 12 is converted as an example of such 24 zones disposed in time domain as illustrated in FIG. 3 through FIG. 5 to exemplify via integration of aforementioned new mass transfer method, differential set-up between resin and liquid phases, and a recycle protocols wherein with this disclosed apparatus.

### DETAILED DESCRIPTION OF THE INVENTION

The present invention relates to an apparatus for separating mixture solution of glucose, fructose, and oligosaccharide from a feed solution containing the same. This apparatus constructed in said modules connected in sequence and is carried out in cooperating with aforesaid new mass transfer method, differential set-up between solid and liquid phase, and recycle protocols, which are integrated as hybrid embodiment and named as SSP hereinafter. This broad and generalized SSP is the continuation of U.S. Pat. No. 6,258,176 B1, date of patent July 2001, named as “Process for Continuous Separation of Glucose and Fructose”. There has two other broad and generalized patents, U.S. Pat. No. 6,280,623 B1 patent date of Aug. 28, 2001 and U.S. Pat. No. 6,576,137 B1 patent date of Jun. 10, 2003, same named as “Differential and Continuous Separation Process with Controlled Parameters for Solids and Liquids”. The continuation of current disclosure is therefore characterized as each other's citation. Yet, the significance of SSP over chromatography is further sustained through this application.

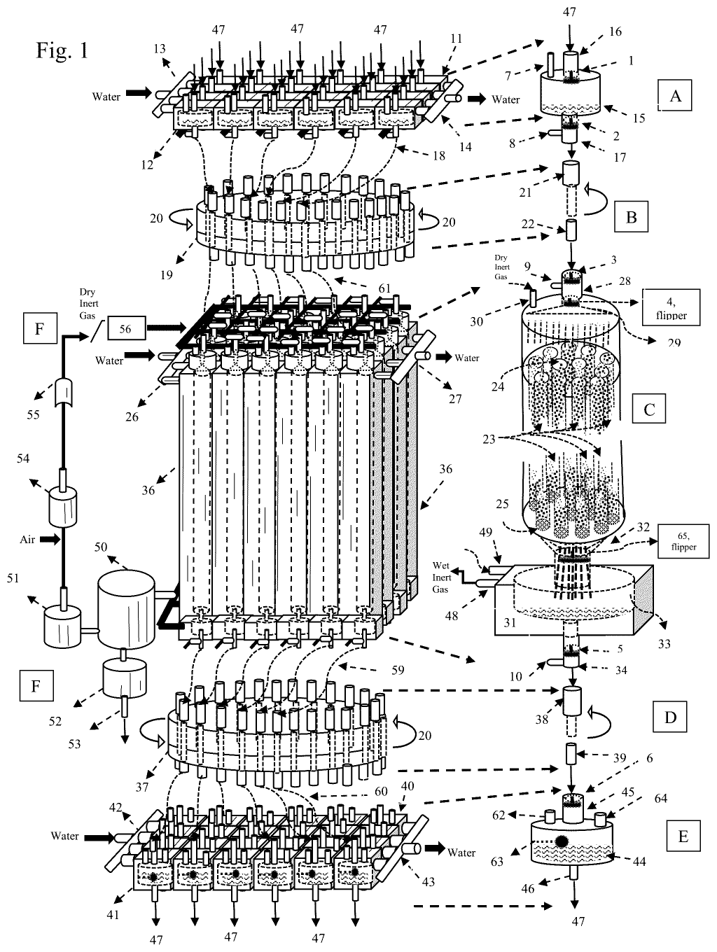

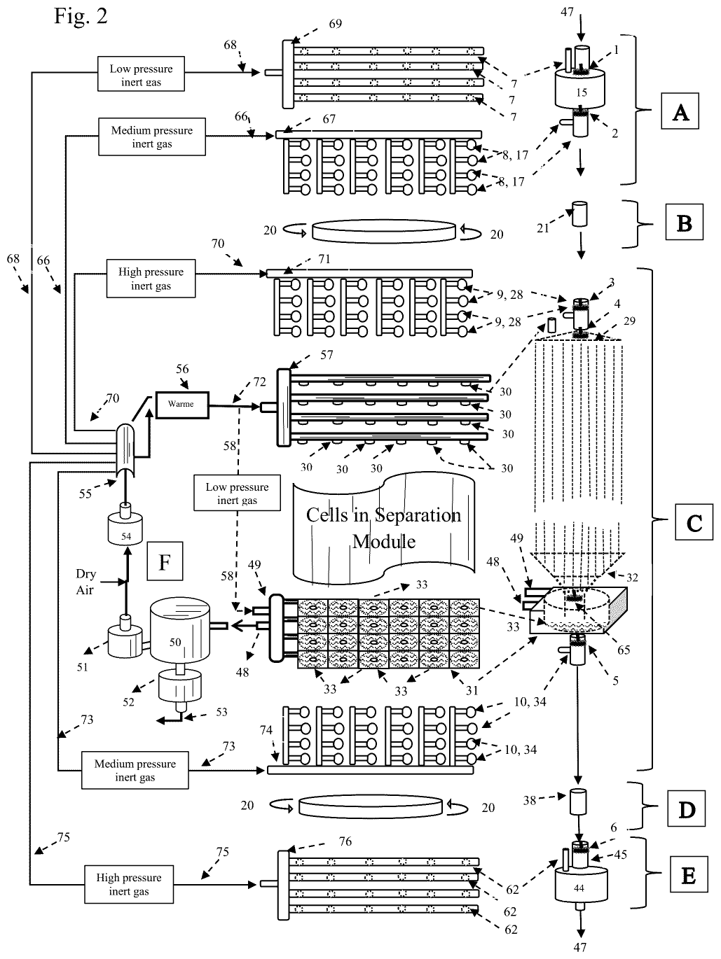

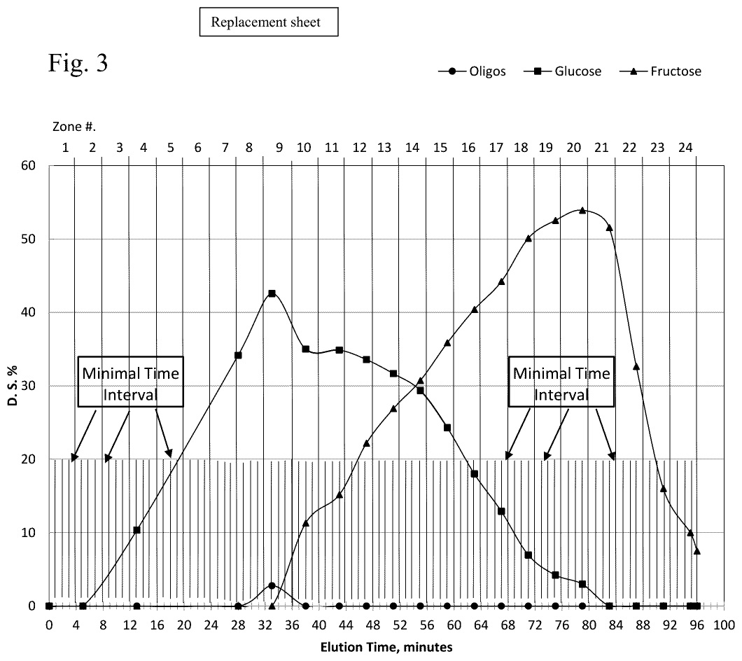

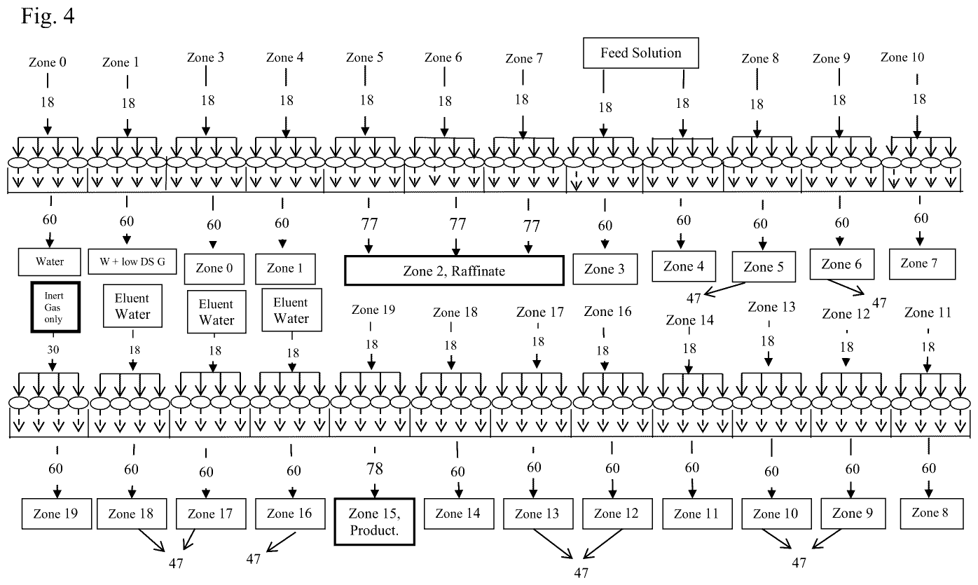

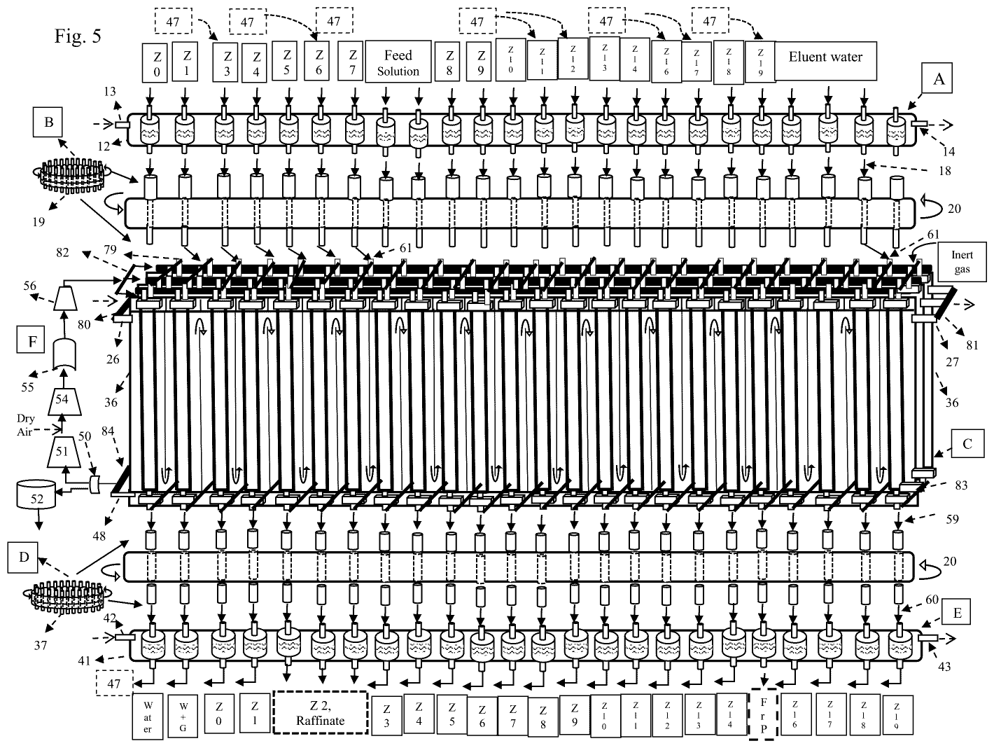

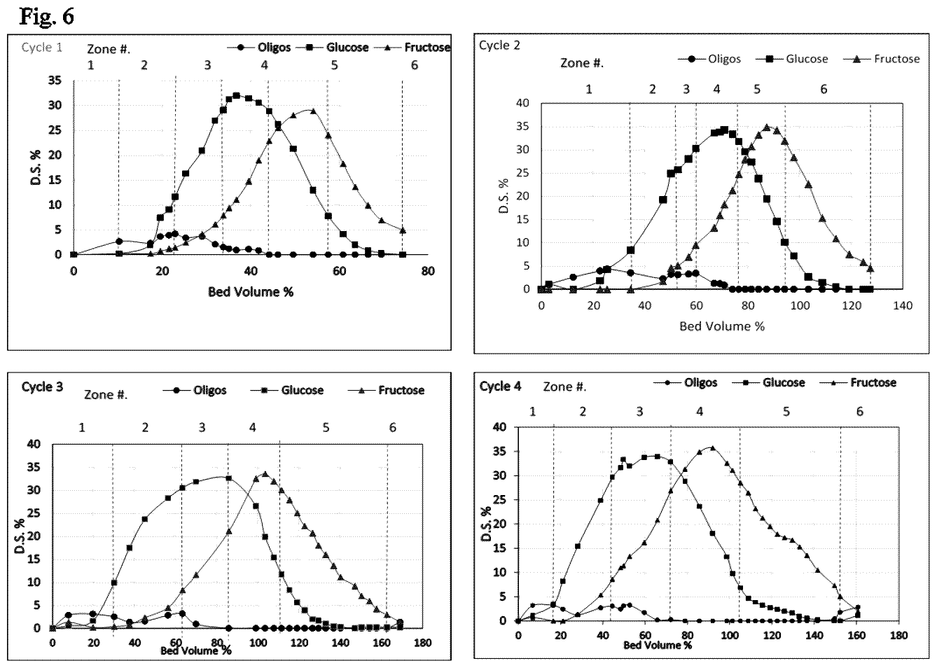

Three preferred embodiments of the current disclosure will be illustrated hereafter namely as preferred apparatus shown in FIG. 1. FIG. 2 illustrates said inert gas supply module integrated with the separation module. The protocols demonstrated in FIG. 3 and FIG. 4 are employed onto this disclosed apparatus for a continuous separation of recovering pure glucose and fructose stream from a feed solution containing the same. In addition, FIG. 5 illustrates single stage recycle protocol for modules connected in sequence to perform separation. FIG. 6 through 12 are examples illustrated for procedures obtaining the elution result shown in FIG. 3 proceeded undergoes aforesaid new mass transfer method.

The bonding capacity measurement of semi-dry status resin is fundamental prior to the application of SSP, wherein the resin is first washed with de-ionized water and followed to undergo vacuum for removing excess water between grains of resin. Said measurement is achieved by adding fixed increment of resin to a prefixed volume of feed solution to promote adsorption of sugar components onto the resin. The total amount of resin consumed in resin capacity measurement is the optimal amount can be proportionally increased with the process throughput for mass production apparatus. In fact, the predetermined amount of resin is equivalent to that in mass transfer zone (MTZ) of a chromatographic operation. Such optimal quantity of resin is installed in each column as plurality of columns disposed a cell in the apparatus, wherein said each column having an inlet on one side and an outlet on another side with bottom meshed filter to contain said material from being drained.

In a chromatographic operation, the MTZ is moving along with fluid stream by inputting additional mobile phase to push off such zone from one end toward other end of column. The time spent is known as displacement zone, wherein the stationary resin is constantly maintained at wet status. The mass transfer equilibrium status is materialized as the mobile phase pass by the stationary resin. Unlike chromatographic operation, this invention is to initiate a new mass transfer method to further utilize the void volume available for prompt mass transfer equilibrium proceeding by eliminating such displacement zone and maintaining resin in a semi-dry status. Said method is composed of following general procedures.
1. Retain solid phase resin material in a bundled group of predetermined quantity of columns, each individual column having an inlet on top side and an outlet on another side with bottom meshed filter to contain equal amount of said resin material from being drained. Bundled group of columns perform like partially fluidized bed as a whole unit and is named as cell hereinafter. Retain solid equal amount of resin material in each column as plurality of columns installed in a said cell, of which the installed resin amount in each column is equivalent to MTZ in chromatography; the inlet of cell is from top and the outlet of cell is from bottom.
2. Deliver predetermined amounts of mobile phase liquid material in dose dropping format via means of supplying pressurized inert gas to either promoting adsorption of dissolved components onto said resin material or elution of adsorbed components from said resin material.
3. Supply another pressurized inert gas to the cell on the top side following each delivery of a mobile phase dose to force prompt draining such mobile phase through said solid phase material to complete expected mass transfer equilibrium between two phases.
4. Maintain a vacuum on the other side of said solid phase material installed in said cell to maintain resin material in a semi-dry status.
5. Intermittently collect of most of treated mobile phase liquid material from the outlet of cell.

Total time spent from step 2 to step 5 is defined as minimal time interval, Δt. Overall, the mechanism of mass transfer equilibrium between two phases and the means of mobile phase delivery are different from those observed in chromatography. In the event, for separation of glucose and fructose, the above-indicated step 2 is proceeded by impulse input S-I mode. It means all mobile phases including feed solution, eluent water and recycled streams from various zones, of which time duration and means of delivering remains unchanged, as step input. The total volume of such mobile liquid phase is subdivided into several predetermined doses and simultaneously delivered as impulse input S-I within a shortest time domain into all cells disposed in specific zone by each said minimal time interval being spent. The step 3 and step 4 of vacuum and/or pressurized inert gas immediately push off the delivered liquid. Such liquid is delivered via a showerhead to sprinkling onto the resin to form a partially wetted region for instantaneous and heterogeneous mass transfer contact to materialize equilibrium status between the drained liquid collected in step 5 and said resin material installed in respective cell.

FIG. 1 is composed as the preferred version of apparatus to better suit for the separation of glucose and fructose. The detailed and general illustration of apparatus itself is an improved version compared in the above-cited patents. The preferred apparatus comprises of five modules function independently and yet coordinate in sequence to achieve separation. For sake of simplicity in illustration, an example of twenty four zones schematic drawing represents the preferred modules shown on left side of drawing and an exploded single unit representing flow of mobile liquid phase on the left side for modules connected in sequence.
A. Upstream Holding Tanks Module A: Having same holding tanks in size for simplicity of drawing or different in size of twenty-four holding tanks as Upstream Holding tanks Module 11, all tanks arranged in an organized array in a selected pattern as preferred set up and denoted as A on right side of drawing. Each said holding tank means for receiving predetermined volume of liquid solution through line 47 via preferred volumetric pump, not shown for drawing simplicity, or not limited via other means of transporting particular liquid from assigned tank in the downstream holding tanks module. Said each of plurality of holding tanks means for intermediate storing of particular liquid solution; and means for transporting all of predetermined volume of such liquid into following module. Such plurality of holding tanks set inside an insulated warm water circulation jacket 12 comprising a warm water inlet via a manifold 13 and warm water outlet via another manifold 14 to maintain whole plurality of holding tanks in a selected temperature range. Such derivation of preferred twenty-four holding tanks will be illustrated in following FIG. 3 and FIG. 4. Each said holding tank representing by a single holding tank 15 of whole plurality has an inlet conduct 16 to receive liquid. Said conduct 16 is extended out of said jacket 11 and is installed with preferred mechanical device flipper 1 inside at bottom of said conduct 16. Low range pressure dry inert gas enters via pipe 7 that is extended out of said jacket 11 and shown next to said conduct 16. Each tank has an outlet 17 extended downward of said jacket 11 to discharge whole of stored liquid. There has a preferred mechanical device flipper 2 installed at top of conduct 17 and there has pipe 8 means for entering medium range pressure dry inert gas. Both conduct 17 and pipe 8 are extended outside of said jacket 11. For simplicity of drawing, only six of front tanks shows by a curve dot line 18 for liquid distribution to the following rotary union multiple valves module B.
B. Upstream Rotary Union Module B: This preferred upstream multiple valves module, denoted as B, having a rotational circular multiple valves body 19 driven by a Servo-motor, not shown for drawing simplicity, rotate intermittently stopped and stepped forward at a predetermined equal angle in a selected clockwise or counter clockwise 20 direction. When valve body 19 stopped means for predetermined volume of all particular liquids are promptly and simultaneously transferred. Said multiple valves body 19 having a plurality of top side liquid transit storage reservoirs 21 installed at predetermined location to simultaneously receiving said predetermined volume of liquid transferred from particular holding tank of above said upstream holding tanks module A. Said rotational valves body 19 having an equal quantity of outlet conduct 22 installed bottom side at corresponding location to precisely transmit said predetermined volume of liquid to next following module as shown on right side exploded diagram. Soon received all kind of liquid in each said reservoirs 21 is satisfied, valve body 19 steps forward one rotation angle step, then to transmit stored liquid to following module and waiting for another round of liquid throughput. At any time interval between stopped and rotation step forward of said valve body 19, all kinds of liquid stored in each said holding tanks module A is simultaneously delivered from particular holding tank via Upstream Rotary Module B to the following module. It is contrast different from liquid handling observed in chromatographic process or nowadays well adopted SMB process.
C. Separation Module C: Having a plurality of said cells arranged in preferred pattern wherein is denoted as C. As aforesaid each cell comprising a plurality of columns 23, each column has a top side opening 24 means for liquid input and bottom screen filter 25 means for retaining equal amount of said resin from been drained. All cells arranged in a similar organized array of said holding tanks module as preferred set up for easier organizing liquid flow from corresponding holding tank in said holding tanks module A via said rotary union module B. Such group of cells set inside an insulated warm water circulation jacket 36 comprising a warm water inlet via a manifold 26 and warm water outlet via another manifold 27 to maintain whole plurality of cells in a selected temperature range. Such derivation of preferred twenty-four cells will be further illustrated in following FIG. 3 and FIG. 4. As shown on right side exploded diagram, each cell has a liquid inlet conduct as temporary transit reservoir 28 extended out of the water jacket to receive particular liquid delivered; through preferred mechanical device flipper 3 located at reservoir 28 top, via said upstream rotary union module B from corresponding holding tank and via a showerhead 29 down below. Such showerhead 29 comprising of a top side preferred mechanical device flipper 4 installed inside between bottom side of reservoir 28 and top side of showerhead 29 via controlling on and or off of entering pressurized inert gas to intermittently drop in parts of delivered liquid out of reservoir 28 or stop transmitting such stored liquid as aforementioned impulse input S-I. There has a pipe 9 located between said flipper 3 and flipper 4 as shown means for entering high range pressurized dry inert gas into said reservoir 28. Each cell top has a pipe 30 means for simultaneously and intermittently receiving supply of high range of pressurized dry inert gas.

Each cell bottom is exposed to closed vacuum environment 31; such vacuum exerted via inert gas supply module will be further illustrated in FIG. 2, having an exit for wet inert gas via pipe 48 to maintain said resin in a semi-dry status, and to affiliate liquid draining via funneled shape liquid conduct 32 into each underneath temporary liquid reservoir 33 means for collected liquids from various zones redistributed for further applications. There has manifold 49 means for supplying low range pressurized inert gas when vacuum 31 is shut off. Said liquid conduct 32 installed inside with a preferred mechanical device flipper 65. Each bottom of liquid reservoir 33 has a liquid conduct 34 and its bottom inside installed a preferred mechanical device flipper 5 wherein has a pipe 10 connected to conduct 34 located below flipper 5; both pipe 10 and conduct 34 are extended outward said insulated water jacket 36. Arrange to transfer various liquid stored in respective liquid reservoir 33 into following modules will be illustrated further in following FIG. 2.
D. Downstream Rotary Union Module D: This preferred downstream multiple valves module, denoted as D, having a rotational circular multiple valves body 37 driven by a Servo-motor, not shown for drawing simplicity; rotate in same direction with said upstream rotary union module 19, stepping forward at same predetermined equal angle in a selected clockwise or counter clockwise 20 direction. Said multiple valves body 37 having a plurality of top side liquid transit storage reservoirs 38 installed at predetermined location to simultaneously receiving said drained all kind of liquids transferred via each liquid conduct 34 of above aforesaid separation module C. When valves body 37 stopped means all kind of liquids collected in each cell bottom reservoirs 33 are simultaneously delivered and stored in said reservoir 38. This rotational valves body having an equal quantity of outlets conduct 39 installed at corresponding location to precisely transmit particular liquid to the assigned holding tank in following downstream holding tanks module. Soon all kind of liquids available in said reservoir 38 simultaneously transmitted via conduct 39 are completed, valves body 37 stepped another predetermined rotation step to repeat aforesaid operation; in event of steady state operation wherein valve body advance one rotation step means disclosed apparatus achieve one complete separation cycle.
E. Downstream Holding Tanks Module E: Having same holding tanks in same size for simplicity of drawing or different in size of twenty-four holding tanks 40, denoted as E. Each holding tank is assigned for receiving particular liquid via each conduct 39 of above mentioned downstream rotary union module D; arranged in an organized array in a selected pattern as preferred set up. Such group of holding tanks set inside an insulated warm water circulation jacket 41 comprising a warm water inlet via a manifold 42 and warm water outlet via another manifold 43 to maintain whole plurality of holding tanks in a selected temperature range. Such derivation of preferred twenty-four holding tanks will be illustrated in following FIG. 3 and FIG. 4. Each holding tank representing by a single holding tank 44 of whole plurality has an liquid conduct 45 wherein installed top with preferred mechanical device flipper 6; such liquid conduct 45 extended out of said jacket 41 means for freely receiving particular liquid via opened flipper 6 and has a liquid conduct 46 extended downward of said jacket 41 means for discharging stored liquid via line 47 as pure glucose Raffinate into assigned storage tank; means for discharging pure fructose via another line 47 as Product in another assigned storage tank; and means for transmitting in part of available liquid stored in respective holding tank 44 via 47 in predetermined volume recycling back via each volumetric pump, not shown for drawing simplicity, into each assigned holding tank in aforesaid upstream holding tanks module A. There has a pipe 62 installed next to conduct 45 means for supplying high range pressurized inert gas. There has a preferred liquid level sensor 63 installed inside each holding tank 44 to maintain predetermined liquid level of stored liquid within, means such level sensor 63 is to control delivering sufficient volume of predetermined composition of sugar mixture via liquid conduct 64 to maintaining a predetermined liquid level setting in respective holding tank 44. For simplicity of drawing, only six of front tanks shows by a line 47 for particular liquid distribution to respective assigned holding tank of said upstream holding tanks module A; except to aforementioned glucose Raffinate storage tank and to fructose Product storage tank.
F. Inert Gas Supply Module F illustrated in FIG. 2 and denoted as F focusing on routing for supplying broad range pressurized inert gas to incorporate with said module A, B, C, D and module E; each module is briefly illustrated on right side of this figure wherein are all detailed in FIG. 1. Briefly generalized regions in disclosed apparatus comprise closed vacuum environment loop, upstream broad range inert gas supplying loop, and downstream broad range inert gas supplying loop.
   1. Closed vacuum environment loop: As aforementioned of each cell bottom of separation module C is exposed to said closed vacuum environment 31; such vacuum 31 shown on mid part of this FIG. 2 comprising manifold conduct 48, mist separator 50, central vacuum pump 51, means for simultaneously prompt liquid draining into each said plurality of temporary liquid reservoirs 33 and meanwhile extracting water mist enriched wet inert gas to maintaining said resin in a semi-dry status to meet criterion of new mass transfer method; means to create a heterogeneous contact as liquid promptly sipping through stationary resin particles; and means for converting wet inert gas to dry inert gas. The whole time, water mist enriched inert gas exited said manifold 48 first passing through mist separator 50 to remove water moisture, prefer using cold water condenser to condense water moisture to store collected liquid water in reservoir 52 via liquid conduct 53 to recycle water. Such dry inert gas exiting mist separator 50 is combined with pressurized dry air and deployed through an inert gas generator 54 to obtain fresh dry inert gas and to store in a steel tank vessel 55 maintaining at preferred broad range of pressure level inert gas ready for deploying back to following modules;
   2. Upstream broad range inert gas supplying loop means for upstream holding tanks module A and cell top in separation module C: via line 66 out of said tank vessel 55 supplying medium range pressurized inert gas through manifold 67 for upstream holding tanks A to simultaneously deploys via respective pipe 8, whereas low pressure inert gas via pipe 7 is shut off; so that flipper 1 is opened to allow predetermined liquid volume transferred from assigned tank in said downstream holding tanks module E via said each volumetric pump freely passing through via line 47 whereas flipper 2 is pushed upward to block liquid from flowing downward to temporarily store delivered liquid into each holding tank 15 in said upstream holding tanks module A;

As above mentioned operation is concluded, medium pressure inert gas via pipe 8 is promptly shut off; meanwhile simultaneously out of tank vessel 55 via line 68 to supply low range pressurized inert gas through manifold 69 via each pipe 7, together yet separately via line 70 to supply high range pressurized inert gas through manifold 71 via each pipe 9; such operation resulting to close both flipper 1 and flipper 3 and to open flipper 2 for freely liquid throughput via liquid conduct 17 from holding tank 15 into respective transit reservoir 21 in upstream rotary union module B; said rotary valve body shown as upstream rotary union module B promptly advance one rotation step.

Soon said upstream rotary union valve body is stopped, low pressure inert gas via pipe 7 and high pressure inert gas via pipe 9 are both promptly shut off; meanwhile simultaneously out of tank vessel 55 via line 66 to resume supplying medium range pressurized inert gas through manifold 67 via each pipe 8 together yet separately to supply high range pressurized inert gas via line 72 through manifold 57 via each pipe 30 to supply of high pressurized inert gas, so that such operation resulting to simultaneously close said flipper 2 and flipper 4, resulting simultaneously to transmit entire liquid stored in respective transit reservoir 21 of valve body via opened flipper 3 into respective reservoir 28 located at top of said separation module C.

Soon aforesaid operation is completed, high pressure inert gas via pipe 9 is promptly turned on in a predetermined short time duration to close flipper 3; whereas inert gas via pipe 30 is meantime shut off, resulting liquid stored inside reservoir 28 to promptly pass freely through flipper 4 to drop in parts of stored liquid during said very short time period to wet top portion of installed solid resin. Then, immediately soon high pressure inert gas supply via pipe 30 is turned on and whereas via pipe 9 is meanwhile shut off, such operation means for pushing back flipper 4 to stop liquid from dropping; means for pushing liquid through said resin contained in each cell to complete expected aforesaid mass transfer equilibrium between two phases. Alternatively repeating operation between on and or off supplying inert gas between pipe 9 and pipe 30 with dividing stored liquid in reservoir 28 in predetermined liquid doses means to proceed differential set up between solid and liquid phase which is governed under current disclosure.
3. Downstream broad range inert gas supplying loop means for all cell bottom in separation module C and downstream holding tanks module E: as aforementioned, bottom of separation C is exposed to closed vacuum environment 31 containing entire bottom part of separation module in order to continuously and simultaneously drain dropped doses of liquid solution from respective cell top to store in respective transit liquid reservoir 33, wherein such reservoir having widely opened top. Meanwhile, medium range pressurized inert gas out of said tank vessel 55 through line 73 via manifold 74 via each pipe 10 is simultaneously turned on, such operation means for supplying medium pressure range inert gas when vacuum 31 is exerted to push upward said flipper 5 to hold drained liquid stored in respective holding tank 33.

Promptly after liquid draining is completed, whereas vacuum 31 and said medium range pressurized inert gas via each pipe 10 are both shut off; both low range pressurized inert gas supplied via manifold 49 and high range pressurized inert gas supplied via pipe 62 are promptly turned on, so that both flipper 65 inside funneled conduct 32 and flipper 6 inside liquid conduct 45 are both closed, meanwhile flipper 5 in conduct 34 is opened to allow entire stored liquid in respective reservoir 33 simultaneously freely transferring into each underneath liquid transit storage reservoirs 38 in said downstream rotatory union module D; said valve body in downstream rotary union module advance one rotation step and promptly after multiple valve body is stopped, medium pressure range inert gas resume supplying via pipe 10 and high range pressurized inert gas supplied via pipe 62 is turned off, such operation resulting to close flipper 5 to push stored liquid in each reservoir 38 freely via liquid conduct 45 through opened flipper 6 into each assigned holding tank in said downstream holding tanks module E.

As aforesaid illustration, this inert gas supply module F is sub-module integrated with said separation module C to incorporate with other modules as disclosed apparatus shown in FIG. 1. During duration of each spent time interval in steady state operation, all kind of liquid solutions simultaneously distributed entire available liquid solution from respective holding tank 15 in upstream holding tanks module A through each transit reservoir 21 in upstream rotary union module B, and simultaneously intermittently disposed into respective cell body in separation module C to carry out mass transfer equilibrium; drained and collected liquid in each transit reservoir 33 transferred via each transit reservoir 38 in downstream rotary union module D into each holding tank in downstream holding tanks module E, through downstream holding tanks module E, recycling back to upstream holding tanks module A in sequence in a close loop to carry out in a form of said new mass transfer equilibrium to continuously achieve separation of glucose and fructose mixture in a repeated manner. Such organized liquid transferring operation is carried out via controlling broad range of pressurized inert gas incorporated with aforesaid modules for this ultimate objective separation of glucose and fructose mixture.

Prior supplying high range pressurized inert gas through line 72 via manifold 57 via each pipe 30 entering said separation module C, there has a preferred inline gas warmer 56 installed to assure fresh dry inert gas maintained slightly above all kind of liquid solutions temperature range means to prevent microbiological growth at preferred temperature range between 60 and 80 Celsius. Maintaining said upstream holding tanks module A, downstream holding tanks module E, and separation module C within predetermined temperature range means for reducing viscosity of sugar solution transmitting, and to prevent microbiological growth. This preferred temperature range is between 55 and 70 Celsius degree.

Preferred broad range pressure level set for inert gas is set in between 40 to 90 psi within pressurized inert gas supply module, wherein preferred low range pressurized inert gas is set in between 40 to 55 psi means for providing enough pressure for quickly pushing liquid into next following upstream rotary union module and or downstream rotary union module, wherein preferred medium range is set in between 55 to 70 psi means for providing enough force onto mechanical flipper to holding the entire transmitted liquid weight, wherein preferred high range pressurized inert gas is set in between 70 and 90 psi means for providing enough force onto mechanical flipper to support the entire transmitted liquid weight and providing enough pressure to push dropped liquid quickly sipping through respective column disposed in each cell, and or pushing entire liquid promptly into assigned holding tank in downstream holding tank module. Preferred inert gas used for this disclosed apparatus is nitrogen, carbon dioxide, argon or mixtures of gas in portions to reduce oxygen oxidation with resin from hindering long term separation efficiency. Preferred vacuum level is between 15 in-Hg to 27 in-Hg. Such inert gas close loop circulation module F integrated with separation module C means for affiliating prompt liquid draining; means for preventing possible microbiological growth; means for as carrier to affiliate removing water moisture as elevated concentration level of various sugar solution during proceeding of glucose and fructose separation; means for reducing eluent water consumption of condensed water; and ultimately reducing energy consumption as well in this disclosed apparatus.

For purpose of large scale process design and construction for a target feed throughput in order to obtain specific glucose and fructose separation; expansion of particular module in size and/or operating of multiple modules in parallel are deemed as part of disclosed apparatus in total; and that is understandable as subset of an expandable disclosed apparatus. Furthermore, such addition of increasing quantity of same module or module connected in sequence as plurality of modules in sequence operated in parallel is also governed under this disclosed apparatus. This modules simultaneously operated in parallel will be readily exemplified in following FIG. 5, whereas other modules as single component with predetermined liquid volume throughputs. For example, said separation module can expand to modules operated in parallel for alternate resin regeneration of particular module without shutting down whole apparatus. Holding tanks in the module can be increased in size and distribute liquid material via upstream rotary module to separation module operated in parallel and distribute back to holding tank module via downstream rotary module. Urgent situation like in event of mechanical failure in particular module, the part of apparatus can be shut down for maintenance without harming other part of apparatus operation. This flexible set up as a whole apparatus among each independently operated modules provide flexibility in throughput requirement, operation smoothness, and reducing down time required for maintenance.

Prior to the implementation of differential set-up between two phases employed onto disclosed apparatus, a preliminary study from a single column for a satisfied separation is required. Such column is as column 23 illustrated in FIG. 1. Such study or test starts from sequentially inputting all kinds of predetermined solution mixtures via said general procedures of new mass transfer method. A preferable 24-zones steady state study result is shown in FIG. 3, wherein the glucose, fructose, and oligosaccharide concentration are plotted as D.S. % (dry solid percentage) in Y-axis vs. elution time in X-axis. The method derived for obtaining such result shown in FIG. 3 will be illustrated later in examples of FIG. 6 through FIG. 12. The steady state means the concentration and the composition of glucose and fructose mixture of respective zone showing little difference among repeated testing. The testing is proceeded by each increment of minimal time interval, Δt, as shown one minute. By the nature of said new mass transfer method, the input of liquid dose is promptly sipping through resin bed installed in a single column and been drained by top inputting of pressured inert gas and affiliated with said bottom vacuum environment. The expected mass transfer phenomena has been executed as delivered liquid been drained through the resin. The concentration and composition of each among all kind of treated sugar mixtures collected from bottom of such cell representing a complete separation cycle. Unlike typical chromatographic elution profile having displacement zone then eluted profile, said new mass transfer method has such profile starting from the beginning of elution time. Through such method, the displacement zone in traditional chromatographic operation has been eliminated and so is the void volume available between resin grains is been utilized for separation. From a single column study means this elution profile illustrated in FIG. 3 representing multiple said mass transfer phenomena equilibrium status are reached in sequence between particular mixtures of sugar solution entering from top of column promptly sipping through resin bed as another composition of sugar mixture collected from column bottom. Comparing with traditional chromatography, this saving in cycle time translates a saving of resin consumption. As shown in FIG. 3, a preferable 24-zones protocols is selected to implement onto disclosed apparatus is capable to continuously recover a raffinate of pure glucose from zone 2 in concentration ranging between 30.0 to 40.0 D.S. % and a product of pure fructose from zone 15 ranging in between 50.0 to 58 D.S. % of elevated concentration. The total cycle time incurred from sequential of all kind of sugar mixture delivered into said single column, including feed, eluent water, and recycled sugar mixtures, and to collecting solution from bottom of a single column from zone 1 through zone 24, is 96 minutes. Yet, the complete separation cycle is achieved via differential mode during duration of each spent of minimal time interval designated for various zones arranged in an endless format.

Actually, there is no specific preference in setting up said number of group cells or number of rotation steps for said of upstream rotary union module B and downstream rotary module D or predetermined minimal time interval assigned for separation module C. It solely depends on the total required time to spent for completing one elution profile divided by the said predetermined minimal time interval, such that to simplify the procedures to minimal complexity to obtain best separation results. In any event, therefore, other alternative protocols may be established, yet, such alternations should be confined within the scope of this disclosure. The general method of differential set-up between solid phase material and mobile phases is composed the following procedures.
1. Sequentially break down the elution profile obtained by said new mass transfer method as demonstrated in FIG. 3 to obtain the partial time required for respective solution is the time needed to spend for such zone, this including feed, eluent water, and recycled streams.
2. Divide each partial time by said minimal time interval to obtain the number of doses for such zone. Then, divides the volume of such liquid by the number of doses to obtain the partial volume required for each dose. Further divides both said resin, which derived from complete saturation with feed solution, and partial volume of such liquid by a pre-selected number that corresponds to at least one cell in a group of cells at each zone to simultaneously receive the partial volume of such liquid for each cell in said group of cells.
3. Sequentially allocate all cells with respective solution as the range of respective zone and allocated all zones into an endless format.
4. Arrange all zones sequentially in an endless circular format representing a complete separation cycle.
5. Prepare predetermined volume of respective solution to store in respective holding tank in said upstream holding tanks module A for such liquid distribution throughout this disclosed apparatus to achieve glucose and fructose separation.
6. For simultaneous delivering of various sugar mixture into respective zone during steady state operation in this disclosed apparatus, by which it transforms the traditional chromatographic separation path from parallel into vertical with mobile phase's flow direction. For purpose of glucose and fructose separation, FIG. 3 clearly illustrates sugar mixtures in feed stream that glucose is migrating toward left side of elution profile, whereas fructose is migrating toward right side of elution profile to achieve separation object. At any instance of steady state operation, a complete separation cycle is accomplished after every spent time for all zones through elution result of said single column testing. FIG. 3 shows each four minutes is the time spent for a complete separation cycle.

FIG. 4 exemplifies preferred twenty-four zones set up employed via said differential set-up protocols onto disclosed apparatus for inputting sugar mixtures of feed solution, various recycle sugar mixtures, and eluent water; each stored in assigned holding tank 15 in upstream holding tanks A and its output distribution thereafter; and wherein various recycle sugar mixtures transferred from each stored in respective holding tank 44 in said downstream holding tanks E. This part has been illustrated in FIG. 1. This FIG. 4 outlines such complete separation cycle, which is based on one minute as minimal time interval, Δt; 4 minutes per zone or total 24 zones arranged in sequence to reflect the profile derived in FIG. 3. In fact, one minute per step is randomly chosen and it can be in multiple as another predetermined minimal intervals, which is interpreted as a predetermined major zone to proportionally reduce number of zones with modification of procedures. This figure further illustrates the single stage recycle protocol for elevating the concentration level of separated product. All of minimal time interval, Δt, are simplified by an “oval” arranging in an endless circular in upstream rotary union valves module B and downstream rotary union valves module D. From a single column study means this elution profile illustrated in FIG. 3 representing multiple said mass transfer phenomena equilibrium status are reached in sequence and yet simultaneously employed via this disclosed apparatus to carry out mass transfer equilibrium between particular mixtures of sugar solution entering from top of column promptly sipping through resin bed as another composition of sugar mixture collected from column bottom.

Therefore, for sake of sugar mixture separation, first carry out a start-up state operation means for generating fresh semi-dry status resin installed in separation module C from fresh to reach initial equilibrium status with each incoming sugar mixture, wherein start-up operation comprise following:
1. through means of aforesaid liquid delivery mode illustrated in FIG. 1 and FIG. 2, a predetermined volume of various liquids from respective holding tanks 15 starting internally from Zone 0, then, covering next zone in sequence among Zone 0, 1, 3, 4, 5, 6, 7, feed solution, 8, 9, 10, 11, 12, 13, 14, 16, 17, 18, 19, eluent water, and lastly inert gas being transmitting entire available liquid volume simultaneously via means of pipelines 18 into transit reservoir 21; advance one rotation step through means of rotation mechanism in predetermined rotating direction, then via of pipelines 61 as indicated into each underneath cell's top-inlet for carrying out following mass transfer equilibrium process;
2. intermittently deliver through means of alternated supplying of pressurized inert gas between pipe 30 and pipe 9 following delivery of various liquids in dose of predetermined volume to force draining of dropped liquid promptly sipping through said resin to complete expected mass transfer contact equilibrium between two phases;
3. maintain a vacuum 31 to continuous drain the individual liquid solution into respective underneath temporary reservoir 33 and to maintain resin in a semi-dry status;
4. intermittently collect of all kind of drained liquids in each temporary reservoir 33; transmitting by means of pipelines 59 into transit reservoir 38; advance one rotation step through means of rotation mechanism in predetermined rotating direction, then, through 60 shown in FIG. 1 into each assigned holding tanks 44 in downstream holding tanks module, transmitting predetermined volume out of holding tank 44 via means of pipelines 47 to assigned holding tank 15 in upstream holding tanks module A;
5. Repeating repeatedly step 1 through step 4 initially for zone 0, then “zone 0 together with zone 1” until transit reservoir 21 in upstream rotary union module and transit reservoir 38 in downstream rotary union module return to each initial position to complete one revolution, so that, start-up operation can be concluded, wherein retrieved all kinds of liquids during start-up operation as water for recycle, water with low D.S. glucose solution for other usage, recycle streams of Zone 0, 1, 2, 3, 4, 5, 6, 7, 8, 9, 10, 11, 12, 13, 14, 15, 16, 17, 18, and 19; except the solution collected from zone 2 is glucose Raffinate and solution from zone 15 is fructose product as illustrated in FIG. 1, transmitting all kind of sugar mixtures for recycling except Raffinate and Product, from each assigned holding tank 44 in downstream holding tanks module E via means of pipelines 47 to each corresponding holding tank 15 in upstream holding tanks module A.

Soon, start-up operation is concluded, thereafter disclosed apparatus can shift into steady state operation. Through all kind of liquids set for all zones arranged in FIG. 4 through means of liquid delivery described in FIG. 1 to obtain such satisfied sugar mixture separation illustrated in FIG. 3. Within time spent assigned for each zone, such plurality of transit reservoirs 21 simultaneously receive entire available predetermined amount of various kinds of liquid delivery and simultaneously transmitted into respective cell proceeding said new mass transfer method illustrated in separation module C to obtain each drained sugar mixtures from respective cell bottom as next steady state operation. The same procedures repeat repeatedly as following steady state operation;
1. through means of aforesaid liquid delivery mode illustrated in FIG. 1 and FIG. 2, a predetermined volume of various liquids from respective holding tanks 15 of Zone 0, 1, 3, 4, 5, 6, 7, feed solution, 8, 9, 10, 11, 12, 13, 14, 16, 17, 18, 19, eluent water, and lastly inert gas are simultaneously transmitting entire available liquid volume via means of pipelines 18 into transit reservoir 21; advance one rotation step through means of rotation mechanism in predetermined rotating direction, then via of pipelines 61 as indicated into each underneath cell's top-inlet for carrying out following mass transfer equilibrium process;
2. intermittently deliver through means of alternated supplying of pressurized inert gas between pipe 30 and pipe 9 following delivery of various liquids in dose of predetermined volume to force draining of dropped liquid promptly sipping through said resin to complete expected mass transfer contact equilibrium between two phases;
3. maintain a vacuum 31 to continuous drain the individual liquid solution into respective underneath temporary reservoir 33 and to maintain resin in a semi-dry status;
4. intermittently collect of all kind of drained liquids in each temporary reservoir 33; simultaneously transmitting by means of pipelines 59 into transit reservoir 38; advance one rotation step through means of rotation mechanism in predetermined rotating direction, then, through 60 shown in FIG. 1 into each assigned holding tanks 44 in downstream holding tanks module; wherein all kind of liquids retrieved as water for recycle, water with low D.S.-glucose solution for other usage, recycle streams of Zone 0, 1, 2, 3, 4, 5, 6, 7, 8, 9, 10, 11, 12, 13, 14, 15, 16, 17, 18, and 19; wherein the solution collected from zone 2 is glucose Raffinate and solution from zone 15 is fructose product.
5. As illustrated in FIG. 1, transmitting all kind of sugar mixtures for recycling except Raffinate and Product, from each assigned holding tank 44 in downstream holding tanks module E via means of pipelines 47 to each corresponding holding tank 15 in upstream holding tanks module A.

All the repeated procedures are accomplished during accumulation of each spent of said minimal time interval, Δt, which is covered from step 1 through step 4. Such minimal time interval specified in FIG. 3 represents the elution profiles gained from a single cell's study. Through implementation of said new mass transfer method and said differential set-up between two phases onto disclosed apparatus, every four minutes time spent for each particular liquid zone is equivalent to one separation cycle. Nevertheless, this invention has shown that the traditional mass transfer path occurred in chromatography, typically in parallel with liquid flow direction, has been converted into perpendicularity with flow direction. The aqueous feed solution is introduced via line 47 located in between recycled stream of zone 7 and zone 8, wherein feed solution has glucose content slightly lower than that in zone 7 and slightly higher than that in zone 8. The component of glucose and fructose originally contained in the feed solution is thus migrating horizontally through recycle streams toward zone 2 recovered as a raffinate stream of pure glucose via line 77, and toward zone 15 recovered as a product stream of pure fructose via line 78. Furthermore, the traditional chromatography spends extra time for pushing off the displacement zone, in which the separated component is travelling with bulk liquid flow. This invention has demonstrated the elimination of such displacement zone and therefore the cycle time is dramatically reduced to 4 minutes, thus, the resin inventory, eluent water consumption, and other unspecified operation cost can be diminished proportionally.

As shown in schematic drawing of FIG. 5, this drawing means for briefly reiterating exemplifies preferred twenty-four zones set up illustrated in FIG. 4 in connection with FIG. 1 on all kind of liquid flow route during steady state operation and meanwhile emphasizing preferred insulated warm water circulation jacket for upstream holding tanks module A, separation module C, and downstream holding tanks module E; wherein all comprising units in above said three modules are arranged in an endless format as another preferred set up pattern. Meanwhile, this figure further illustrates multiple separation module C simultaneously operated in parallel exemplified in three of such modules.
1. Via aforesaid respect pipeline 47 out of downstream holding tanks E transmitting all kind of recycle mixture in predetermined volume of Zone 0, 1, 3, 4, 5, 6, 7, 8, 9, 10, 11, 12, 13, 14, 16, 17, 18, and zone 19 except zone 2 glucose raffinate and zone 15 fructose product to corresponding assigned holding tank in upstream holding tanks module A; such plurality of holding tanks of module E arranged in said endless format inside said insulated warm water circulation jacket 41 having a manifold inlet 42 and manifold outlet 43 for water circulation to maintain whole plurality of holding tanks in a selected temperature range;
2. Via aforesaid respect pipeline 47 transferring above said recycling liquid into each of corresponding plurality of holding tanks in said upstream holding tanks module A arranged in same endless format; installed in water circulating jacket 12 having a manifold inlet 13 and manifold outlet 14 for water circulation; and further
3. Via aforesaid respect liquid pipeline 18 transmitting entire specified recycle stream in predetermined volume from respective tank in said upstream holding tanks A of zone 0, 1, 3, 4, 5, 6, 7, feed solution, zone 8, 9, 10, 11, 12, 13, 14, 16, 17, 18, and zone 19, eluent water, and inert gas are simultaneously delivered via means of pipelines 18 into said upstream rotary union valves module B; wherein said upstream rotary union valves module B having a valve body 19 comprising a plurality of top side liquid transit storage reservoirs arranged in an endless format, installed at predetermined location to simultaneously receiving said predetermined volume of liquid transferred from particular holding tank of above said holding tanks module A. Said valves body 19 having an equal quantity of outlet conduct installed at bottom side of corresponding location of such valve body means for transferring all kind of liquids via each manifold alike 79 disposed above top portion of respective separation module C to precisely transmit said predetermined volume of liquid in equal portion simultaneously into each corresponding cell top of such module operated in parallel; soon top side liquid transit reservoir receiving entire liquid solution is completed, advance one rotation step through means of rotation mechanism in predetermined rotating direction.
4. Via aforesaid each liquid pipeline 61 as indicated into following multiple separation module C operated in parallel;
   a. wherein said each module C comprising plurality of columns with top opening and bottom meshed filter installed in each cell and all cells arranged in an endless format disposed in an preferred insulated water circulation jacket 36, such jacket having plurality of baffle plates vertically installed to confine each cell inside a predetermined compartment, such plate alternatively arranged as indicated to allow water freely enter from one inlet and exit next outlet into next compartment; so that warm water entered via each manifold alike 80 through each liquid conduct 26 of respective jacket 36, freely circulating through first cell in each module, then continue enter 2nd cell, 3rd cell until water stream pass through all confined cell compartments, then exit each of said jacket 36 via manifold alike 81 through each liquid conduct 27 as indicated to maintain all installed cells in an predetermined temperature range of multiple separation module C operated in parallel.
   b. Aforesaid particular liquid transferred via respective pipeline 61, only showing six of such pipeline to simplify drawing, through each said manifold 79 disposed above of particular cell top to distribute such liquid in equal portion through each cell's top liquid inlet means for wetting partial of contained resin in a cell; intermittently and simultaneously deliver through means of integrated inert gas supply module F to force draining of delivered liquid dose sipping through said resin to complete expected mass transfer contact equilibrium between two phases;
   c. Maintain a closed vacuum environment of each cell bottom of respective separation module C operated in parallel to drain the particular liquid into respective underneath temporary reservoir as indicated and to maintain resin in a semi-dry status.
   d. Aforesaid integrated inert gas supply module F with each separation module being operated in an closed loop exerted evenly onto entire bottom portion of multiple separation module C operated in parallel, such vacuum environment being exerted via a central vacuum pump 51; wherein inert gas supply module F comprising manifold alike 84 disposed around each cell bottom portion of respective separation module C via each gas pipe 48 connected to respective separation module C operated in parallel to extract water moisture enriched wet inert gas; first through mist separator 50 to convert wet to dry inert gas and meanwhile to collect water liquid in reservoir 52 for recycle; such vacuum exerted around each cell bottom means to maintaining said resin in a semi-dry status to meet criterion of new mass transfer method; means to create a heterogeneous contact as liquid promptly sipping through stationary resin particles to reach mass transfer equilibrium status. Such dry inert gas exiting mist separator 50 is combined with pressurized dry air and deployed through an inert gas generator 54 to obtain fresh dry inert gas and to store in a steel tank vessel 55 maintaining at preferred broad range of pressure level ready for deploying back to said top portion of each separation module C operated in parallel via inline warmer 56 through each manifold alike 82 disposed above each cell top portion of respective separation module to promptly force out dropped dose of all kind of liquid to carry out mass transfer equilibrium through solid phase resin material and gathering collected liquid in each bottom cell liquid reservoir as preferred operation into downstream holding tanks module F.
5. Intermittently collect of all kind of drained liquids from respective cell bottom of each said separation module C operated in parallel; wherein transmitting altogether of such same liquid via means of respective manifold alike 83 disposed underneath each particular cell bottom portion of respective separation module C through each liquid pipelines 59 into said downstream rotary union valves module D, wherein said downstream rotary union valves module D having a valve body 37 comprising a plurality of top side liquid transit storage reservoirs arranged in an endless format, installed at predetermined location to simultaneously receiving said predetermined volume of liquid transferred from particular transit reservoir of above said separation module C operated in parallel, and wherein said valves body 37 having an equal quantity of outlet conduct installed bottom side at corresponding location to precisely transmit said predetermined volume of liquid; soon top side liquid transit reservoir receiving entire liquid solution is completed, advance one rotation step through means of rotation mechanism in predetermined rotating direction.
6. Via aforesaid respect liquid pipeline 60 transmitting entire specified stored liquid solution at downstream rotary union valves module D as indicated in this FIG. 5; into each assigned holding tank in downstream holding tanks module E; wherein retrieved liquid as water for recycle, water with low D.S.-glucose solution for other usage, recycle streams of Zone 0, 1, 2, 3, 4, 5, 6, 7, 8, 9, 10, 11, 12, 13, 14, 15, 16, 17, 18, and 19; wherein the solution collected from zone 2 is a Raffinate of pure glucose and solution from zone 15 is a product of pure fructose; wherein said downstream holding tanks module E arranged in same endless format; installed in water circulating jacket 41 having a manifold inlet 42 and manifold outlet 43 for water circulation to maintain whole plurality of holding tanks in a selected temperature range as shown in bottom part of FIG. 5.

Repeating step 1 through step 6 as indicated in this FIG. 5 means to illustrate steady state operation protocol of this disclosed invention for object of continue separation of glucose and fructose sugar mixture operated simultaneously exemplified in three of such separation module C in parallel.

As earlier illustration of resin installed in each cell of apparatus is the like amount of mass transfer zone, abbreviated as MTZ, in chromatographic operation, which is directly related to the maximum bonding capacity of resin in a semi-dry condition. Under this foregone guideline of new mass transfer method, the bonding capacity is irrelevant to concentration of sugars mixture in aqueous feed solution (D.S. %); except for fact is mattered with the absolute weight of bonded sugars vs. resin's bonding capacity. Thus, the feed solution can be input ranging from as low as 10 to high as 70 D.S. %. In this invention, the 60 D.S. % is selected for demonstration and predetermined condition in single cell experimental testing due 60 D.S. % is most popular in SMB process. In general, the higher concentration of D.S. % in feed solution is preferable simply because less in volume to handle.

Under the same foregone guideline, the amount of de-ionized water consumed undertones irrelevant to its fluid kinetics; including fluid dynamics, flow rate, and flow pattern that are extremely critical in chromatographic operation. Because the separation parameters of target system are derived directly from the predetermined elution profiles, which are then well implemented by the apparatus. The amount of eluent consumption is directly related to how fast the elution can be completed. It means how fast the apparatus can manage the various fluids in a most prompt and efficient manner to achieve the elution within a least spent time for respective zone. Apparently, this water consumption is calculated and obtained directly from experimental study proceeded undergo new mass transfer method, which is based on 100% usage of resin in apparatus in conjunction with absolute weight of sugars loaded in such resin. Note that the recovered water from exit wet inert gas in mist separator and water recovered for zone 0 illustrated in FIG. 4 can be reused, which can be deducted from total water consumption.

In appreciation of new mass transfer method, the inter-resin particle fluid is removed via vacuum to constantly maintain resin at semi-dry status. Issues may hamper to deteriorate separation efficiency in current chromatographic operation like widely used SMB, such as said fluid flow dynamics, resin mesh size related to pressure loss, and related mass transfer resistance to access adsorption sites in porous resin is irrelevant in present disclosure. Simply because the removal of fluid in between resin particle by vacuum exposes the area available for mass transfer to maximum thus allowing the ligand exchange equilibrium and water elution to wash out sugar component proceeding in a most efficient manner. A type of resin, calcium base strongly acidic cation exchanger with mean particle size of 320 μm±10 μm, been broadly adopted in most industrial SMB process is chosen in this invention. It is intentionally employed for direct comparison to undergird facts between this invention and traditional process in term of resin and eluent consumption. In general, it is preferable in using smaller mesh size of resin particle to possess larger available mass transfer contact area, because the pressure loss is less critical in this invention. The operation temperature is preferable in range of 60° to 85° C. to prevent microorganism growth and thus reducing the viscosity for easy flow of sugar mixture in recycling procedures.

The objects and protocols of this invention can be readily comprehended from the following examples, tables, and resin inventory calculated for a specified throughput for aforesaid apparatus and process. To avoid repeated illustration in examples, the specifications of primary components are listed as following.
Feed solution: High Fructose Corn Syrup received from domestic corn refiner, having composition of Fructose 43.05%, Glucose 51.09%, and balance of Oligos, with concentration of 71.1% dry substance. This homogeneous aqueous liquid mixture is diluted with dirt-free de-ionized water to 60% dry substance.
Resin: Dowex Monosphere 99, Calcium base strongly acidic cation exchanger with mean particle size of 320 μm+10 μm.

Above said aqueous feed solution provided from domestic corn refiner and same resin specification are investigated via single column testing, through which to demonstrate significant distinction of mass transfer phenomena between this disclosure and other chromatographic operations. The column dimension is 1.27 cm in I.D. with 203.2 cm column bed height, this column is jacked in 65° C. water circulation. The resin is filled in bed with total 190.5 cm in height and is 241 cc in bed volume. Unlike chromatography, the resin is saturated with water. The new mass transfer method is proceeded under 27 inch-Hg vacuum applied from bottom of bed to continuously drain off the inter-particle's fluid. The said transit reservoirs of feed solution, recycled streams, and eluent water are jacketed with 65° C. water circulation. All liquid inputs are simulated by a quick stroke of liquid pipette to deliver the predetermined volume of such liquid in a form of said impulse input S-I during each very short time duration. The bottom of bed is equipped with an airtight easy thread on and off bottle for sample collection by every prearranged time interval, which is said minimal time interval. The vapor recovery unit jacketed with circulated cold water is installed in between the bed and vacuum pump, and the condensed water will be collected from bottle installed under such condenser. In between each dose of liquid delivery, the pressurized inert gas is supplied from top of column to affiliate with vacuum for fast liquid draining. Those experimental features are actually set to simulate aforesaid new mass transfer method and employed in accordance with the disclosed apparatus as illustrated in FIG. 1 through FIG. 5 for upstream holding tanks A of inputting of sugar mixtures including feed solution, for upstream rotary union valves module B for precise liquid distribution, for separation module C integrated with inert gas supply module F to preform separation, further for drained liquid via downstream valves body D, and finally through downstream holding tanks module E for further liquid distribution during each spent of time interval; except using pressurized air for convince instead of pressurized inert gas for following single column study.

### Example 1

The FIG. 6 shows the characteristic profile of four cycles proceeded under new mass transfer method, in which each cycle's sample concentration is plotted on Y-axis as D.S. % vs. accumulated sample volume converted as Bed Volume % on X-axis. Cycle 1 has 60 cc (25% of bed volume) of feed input via a 2.5 cc/dose every 10 seconds per minute for 4 minutes. Total 24.8 cc of water is collected as sample #1 comprising majority of oligosaccharide; abbreviated as oligos which is like 2-4% minor ingredient in aqueous feed solution. This phenomenon has not been realized in typical chromatography operation, mainly because the column is saturated with water and additional water introduced behind MTZ can result further weakening bounded glucose and fructose to promptly dissolve back to surrounding mobile phase which is water. Typical SMB process using this well-known phenomena as the separation basics in current corn syrup separation industry because fructose has stronger bonding affinity than that for glucose with installed resin in column bed. In contrast, said new mass transfer method constantly drain off water ingredient resulting oligos to promptly elute with and meanwhile to maximize bonding affinity between installed resin and sugar components original existed in aqueous feed solution. Furthermore, said new mass transfer method executed via said impulse input S-I in aforesaid separation module C illustrated in FIG. 1 and FIG. 2 can further enhance difference of bonding affinity between glucose and fructose via input of recycle streams, input of homogeneous aqueous feed solution and eluent water in single stage protocol is because water is an ingredient within such aqueous liquid stream. As all kind of sugar solution introduced into each cell top of separation module C, sugar ingredients will be bonded with resin, whereas such water ingredient promptly sipping through resin bed can further pulling glucose profile ahead of fructose profile, to achieve much better mass transfer equilibrium status than those observed in chromatographic operation. Typical chromatographic operation protocol like SMB using eluent water as separation fundamental and yet in an opposite effect in this extent to deteriorating separation efficiency.

Nevertheless, this major distinction in between current disclosure and all other traditional chromatographic operations is obvious in aspect of maximizing resin's adsorption capacity, fully irrelevant with flow dynamics in current disclosure, through all of which enables resin to increase such bonding capacity in terms of much better separation efficiency. This advantage benefited from said new mass transfer method would further be illustrated in following examples of multiple zones, single stage recycle protocols.

The solution collected from sample #1 is zone 1. The water elution is proceeded after feed input by three formats of impulse input S-I and samples are collected. The first input format covers each water dose delivered is 1.0 cc by each 20 seconds interval for total 3 doses in every repeated one minutes interval. For simple notation, the format of impulse input S-I can be denoted as ((1.0 cc/20 sec.)*3/min). The total water input is 3 cc per minute interval. The second format is ((1.0 cc/10 sec.)*6/min.), which is 6 cc per minute interval for six doses of 1 cc for every 10 seconds. The third format is ((1.5 cc/10 sec.)*6/min.), which is 9 cc per minute interval for six doses of 1.5 cc per 10 seconds. Details combinations of input format hereinafter are omitted to simplify illustration. Mainly, the eluent water input is adjusted in a way that to elute most of glucose as front peak and to prolong the fructose peak in farther apart from the glucose peak. As shown in cycle 1, collected samples are selectively combined as solutions of zone 1 through zone 6, which are retained as the input solution of next cycle. The cycle time is 30 minutes, consumed 157 cc of eluent water and 17 cc of condensed water is collected. The input of cycle 2 is proceeded in sequence of zone 2, 3, 4, and 60 cc of feed solution, then zone 5, 6, 124.8 cc of eluent water, and finally the zone 1 solution. Said feed solution is always delivered in between two zones wherein zone 4 having glucose content slightly higher than that in feed solution and zone 5 having glucose content slightly lower than that in feed solution. The cycle time is increased to 36 minutes and 21 cc of condensed water is collected. The elution profile of cycle 2 has a much pure glucose region (Zone 2) in the front peak and has a much pure fructose mixture (Zone 5) in fructose peak. Likewise, the combined samples, as solutions of zone 1 through zone 6 are retained as the input solutions in cycle 3. The same sequence as those in cycle 2 is followed, which is composed of zone 2, 3, 4, 60 cc of feed solution, zone 5, 6, 125 cc of eluent water, and zone 1 solution. The cycle time is 36 minutes and 18 cc of condensed water is collected. Two sugars in feed solution are steadily migrating toward zone 2 as glucose enriched solution and zone 5 as fructose enriched solution. Only zone 2 solution of cycle 3 is retained as raffinate in this cycle. The remaining solutions are input for cycle 4 in sequence as zone 3, 60 cc of feed, 4, 5, 6, 90 cc of eluent water, and zone 1 solution. The cycle time is 36 minutes and 9 cc of condensed water is collected. The table 1 has listed the zone 2 solution as raffinate of glucose enriched solution and zone 5 as product of fructose enriched solution. The recovery percentage of respective sugar is defined as the weight percentage of retrieved sugar that in comparison with the original pure component in part in feed solution. The percentage of respective sugar is defined as the weight of such sugar in part of total output.

TABLE 1

| | | | | Glucose | Fructose |
|---|---|---|---|---|---|
| Zone | Total Output | D.S. % | Recovery % | % | % |
| 2 | 25.7318 grams | 27.58 | 83.79% of glucose | 81.14 | 18.86 |
| 5 | 17.0599 grams | 19.41 | 81.25% of fructose | 10.74 | 89.26 |

### Example 2

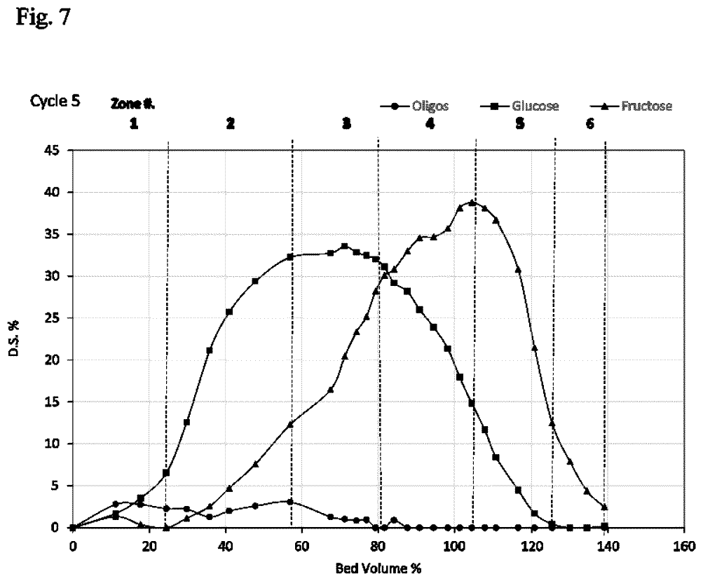

The elution profile shown in FIG. 7 indicates the fifth cycle extended from cycles illustrated in aforementioned figure. The sequence of liquid input is same as those in cycle 4 except zone 5 reserved as product, which are zone 3, 60 cc of feed, 4, 6, 96 cc of eluent water, and zone 1 solution. The cycle time is 37 minutes. Again, the solution collected from zone 2 is retained as raffinate of glucose enriched solution and the solution collected from zone 5 is retained as product of fructose enriched solution. Results are tabulated in Table 2, which demonstrates it has reached steady state that the composition and concentration are maintained constant.

TABLE 2

| | | | | Glucose | Fructose |
|---|---|---|---|---|---|
| Zone | Total Output | D.S. % | Recovery % | % | % |
| 2 | 24.3698 grams | 31.40 | 78.80% of glucose | 81.12 | 18.82 |
| 5 | 16.9526 grams | 31.20 | 86.06% of fructose | 13.8 | 86.20 |

The examples imply that the elution profile maintained steady after several cycles inasmuch as a predetermined number of zones, composition, and concentration of input liquid including feed volume, eluent water and recycled streams are kept constant. Elution profile obtained via above single column study demonstrate aforementioned mass transfer phenomena equilibrium status are reached in sequence between particular mixtures of sugar solution sipping through resin bed as another composition of sugar mixture collected from column bottom.

The following examples focus on objects for establishing protocols by using necessary amount of resin, which is relevant to particular cycle time in order to obtain ultimate purity for raffinate and product and to elevate the concentration of product. The steady-state elution profile is constructed by addition of two zones in concentration ranging in between 40 to 60 D.S. % into the current profile wherein the composition of said zones are predetermined from compositions of retrieved raffinate and product stream of previous profile. By expansion the number of zones, the recycle streams are increased by the number of two in the next profile such that the purity and concentration of separated raffinate and product stream can be improved. Therefore, the amount of glucose and fructose original in a mixture of feed solution are continuously migrating through recycle streams toward two ends of respective profiles until the pure component of respective sugar is obtained.

### Example 3

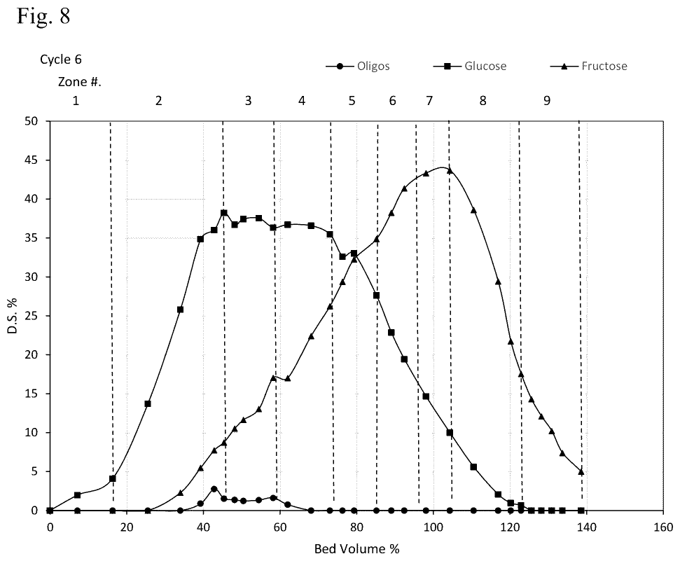

As illustrated in FIG. 8, total nine zones of liquids are collected as the results of sequential input of liquids of zone 3, 4, 60 cc of feed, 5, 6, 20 cc of zone 7, 24 cc of zone 9, 120 cc of eluent water, and zone 1. All streams have predetermined sugars concentration in between 5 to 60 D.S. % and composition in accordance with results in FIG. 7. The input volume of recycled stream of other unspecified stream is 30 cc. Total 10 cc of condensed water is collected during total 50 minutes of cycle time. Alike as those demonstrated in FIG. 7 that the raffinate as glucose enriched solution is recovered from zone 2 and the product as fructose enriched solution from zone 8. Note that the cycle time is increased from 36 to 50 minutes as three addition zones are incorporated into previous profiles to allow glucose and fructose to further migrate through added zones to end of respective profiles. The table 3 has listed the composition and concentration of retrieved raffinate and product, which demonstrates better separation results are obtained than those in six zone protocols.

TABLE 3

| | | | | Glucose | Fructose |
|---|---|---|---|---|---|
| Zone | Total Output | D.S. % | Recovery % | % | % |
| 2 | 22.2852 grams | 29.20 | 90.40% of glucose | 89.61 | 10.39 |
| 8 | 19.8856 grams | 35.80 | 90.30% of fructose | 10.58 | 89.42 |

For avoiding repeated description, the general conditions relevant to the following examples are described hereinafter, through which the procedures can be developed for leading to the separation result demonstrated in FIG. 3. The test column dimension is 0.95 cm in I.D. and 206 cm in bed height. The resin is filled to 195.6 cm in bed height and occupied total bed volume of 139.6 cc. The 36 cc of feed volume are delivered in each example inasmuch as the bed volume is smaller than that in earlier examples. Yet, such 36 cc are equivalent to 25.8% of resin bed volume. Other conditions are remained unchanged as aforementioned examples.

### Example 4

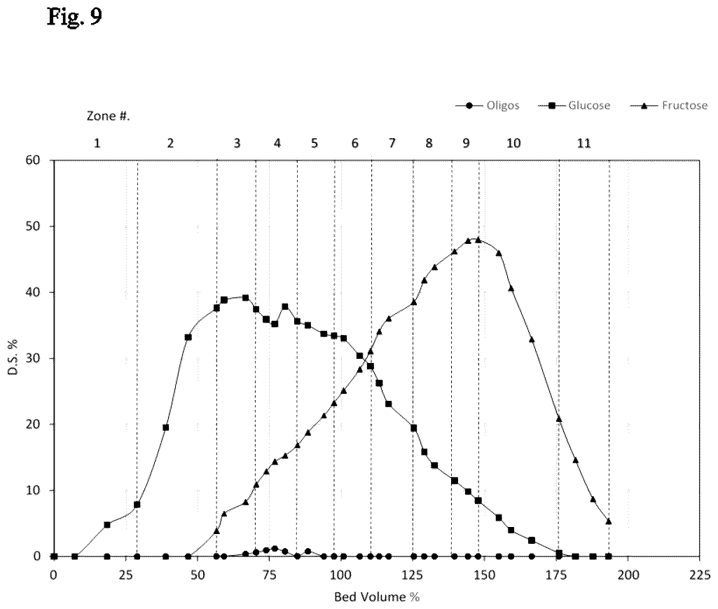

As illustrated in FIG. 9, total eleven zones of liquids are collected as the results of sequential input of liquids of zone 3, 4, 5, feed, 6, 7, 8, 9, 24 cc of zone 11, 63 cc of eluent water, and zone 1. Other unspecified input volume of predetermined recycled stream is 18 cc. Total 3 cc of condensed water is collected. In fact, the zone 3 and zone 9 are the added zones having compositions of two sugars as those specified in Table 3 of zone 2 and zone 8 respectively and each having predetermined concentration of 53 D.S. %. Other recycled streams of zone 3, 4, 5, 6, 7, 9 utilized in example 3 are renamed as zone 4, 5, 6, 7, 8, and 11 respectively with composition and concentration unchanged as liquid input indicated. Alike as those demonstrated in FIG. 8 that the raffinate as glucose enriched solution is recovered from zone 2 and the product as fructose enriched solution from zone 10. Note that the cycle time is increased from 50 to 60 minutes as two addition zones are incorporated into previous profiles to allow glucose and fructose to further migrate through added zones demonstrated in FIG. 9 of respective glucose and fructose profile. The table 4 has listed the composition and concentration of retrieved raffinate and product, which demonstrates better separation results are obtained than those in nine zone protocols.

TABLE 4

| | | | | Glucose | Fructose |
|---|---|---|---|---|---|
| Zone | Total Output | D.S. % | Recovery % | % | % |
| 2 | 13.8567 grams | 31.23 | 93.44% of glucose | 95.43 | 4.57 |
| 10 | 12.1267 grams | 32.58 | 94.69% of fructose | 6.88 | 93.12 |

### Example 5

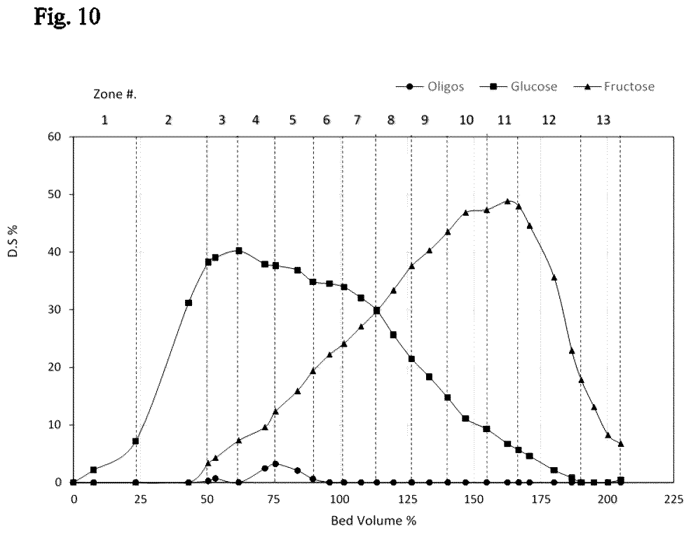

As illustrated in FIG. 10, total thirteen zones of liquids are collected as the results of sequential input of liquids of zone 3, 4, 5, 6, feed, 7, 8, 9, 10, 11, 24 cc of zone 13, 63 cc of eluent water, and zone 1. Total 3 cc of condensed water is collected. Other unspecified input volume of predetermined recycled stream is 18 cc. In fact, the zone 3 and zone 11 are the added zones having compositions of two sugars as those specified in Table 4 of zone 2 and zone 10 and each having predetermined concentration of 48 and 55 D.S. % respectively. Other recycled streams of zone 3, 4, 5, 6, 7, 9, 11 utilized in example 4 are renamed as zone 4, 5, 6, 7, 8, 10, and 13 respectively with composition and concentration unchanged as liquid input indicated. Alike as those demonstrated in FIG. 9 that the raffinate as glucose enriched solution is recovered from zone 2 and the product as fructose enriched solution from zone 12. Note that the cycle time is increased from 60 to 68 minutes as two addition zones are incorporated into previous profiles to allow glucose and fructose to further migrate through added zones demonstrated in FIG. 10 of respective glucose and fructose profile. The table 5 has listed the composition and concentration of retrieved raffinate and product, which demonstrates better separation results are obtained than those in eleven zone protocols.

TABLE 5

| | | | | Glucose | Fructose |
|---|---|---|---|---|---|
| Zone | Total Output | D.S. % | Recovery % | % | % |
| 2 | 14.1856 grams | 34.53 | 96.50% of glucose | 97.60 | 2.40 |
| 12 | 12.4183 grams | 32.58 | 98.06% of fructose | 5.83 | 94.17 |

Following two examples are illustrated for enhancing the concentration level of product from typical 30-35 D.S. % to a higher level as 50-55% D.S.% while the separation purity of product also enhanced. Yet, the same protocols can be applied for raffinate by addition of predetermined zone into glucose profile.

### Example 6

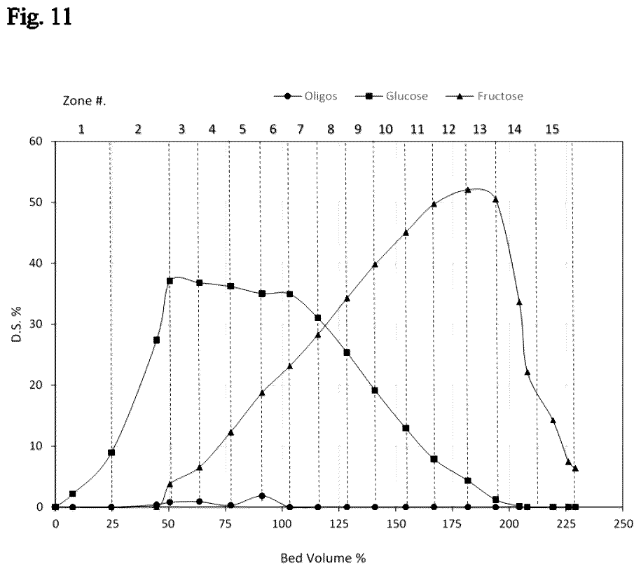

As illustrated in FIG. 11, total fifteen zones of liquids are collected as the results of sequential input of liquids of zone 3, 4, 5, 6, feed, 7, 8, 9, 10, 11, 12, 14, 21.6 cc of zone 15, 62 cc of eluent water, and zone 1. Total 5 cc of condensed water is collected. Other unspecified input volume of predetermined recycled stream is 18 cc. It is slightly different from previous examples that the zone 12 and zone 14 are the added zones. Zone 12 has compositions of two sugars as those specified in Table 5 of zone 12 with concentration at 55 D.S. % and zone 14 has composition of 100% fructose at 33 D.S. %. Other recycled streams of zone 3, 4, 5, 6, 7, 9, and 11 utilized in example 5 are with composition and concentration unchanged as liquid input indicated except zone 13 is renamed as zone 15. Slightly different from those demonstrated in FIG. 10 that the raffinate as glucose enriched solution is recovered from zone 2 and the product as fructose enriched solution from zone 13, which is the third to the last zone. Note that the cycle time is increased from 68 to 76 minutes as two addition zones are incorporated into previous profiles to enhance improvement only on fructose to further migrate through added zones toward end of fructose profile. The table 6 has listed the composition and concentration of retrieved raffinate and product, which demonstrates better separation on product with elevated concentration than those in thirteen zone protocols. Note that the concentration of product is enhanced from usual 30-35 D.S. % to 52 D.S. % as indicated.

TABLE 6

| | | | | Glucose | Fructose |
|---|---|---|---|---|---|
| Zone | Total Output | D.S. % | Recovery % | % | % |
| 2 | 14.0146 grams | 33.85 | 94.85% of glucose | 97.33 | 2.67 |
| 13 | 11.8931 grams | 52.06 | 96.03% of fructose | 2.8 | 97.20 |

### Example 7

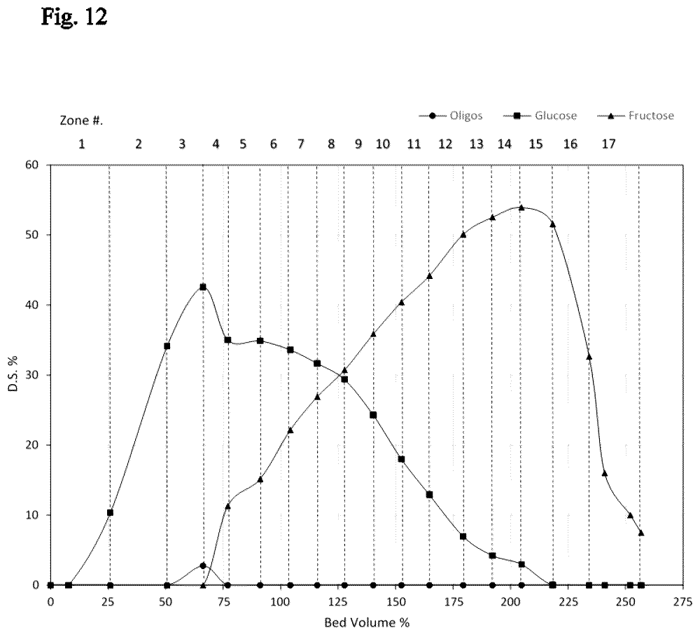

As illustrated in FIG. 12, total seventeen zones of liquids are collected as the results of sequential input of liquids of zone 3, 4, 5, 6, 7, feed, 8, 9, 10, 11, 12, 13, 14, 22.5 cc of zone 16, 25.2 cc of zone 17, 58.5 cc of eluent water, and zone 1. Total 5 cc of condensed water and 10.8 cc of zone 1 are retrieved to make net water consumption of 42.7 cc in volume. Thus, the volume ratio of water to 36 cc of feed is 1.19. Other unspecified input volume of predetermined recycled stream is 18 cc. Again, it is slightly different from example 6. The zone 3 is the added zone having compositions of two sugars as those specified in Table 6 of zone 2 and having predetermined concentration of 45 D.S. %. Zone 14 is the other added zone having composition of 95% fructose and 5% of glucose at 55 D.S. %. Other recycled streams of zone 3, 4, 5, 6, 7, 8, 9, 10, 11, 12, 14, and 15 utilized in example 6 are renamed as zone 4, 5, 6, 7, 8, 9, 10, 11, 12, 13, 16, and 17 respectively with composition and concentration unchanged as liquid input indicated. Alike as those demonstrated in FIG. 11 that the raffinate as glucose enriched solution is recovered from zone 2 and the product as fructose enriched solution from zone 15. Note that the cycle time is increased from 76 to 86 minutes as two addition zones are incorporated into previous profiles to allow glucose and fructose to further migrate through added zones toward the end of respective profiles. The table 7 has listed the composition and concentration of retrieved raffinate and product, which demonstrates the ultimate separation results are obtained on both raffinate and product with elevated concentration. The concentration of nearly pure fructose product is elevated to over 51 D.S. % as indicated.

TABLE 7

| | | | Recovery | Glucose | Fructose |
|---|---|---|---|---|---|
| Zone | Total Output | D.S. % | % | % | % |
| 2 | 14.1520 grams | 35.7 | 100% of | 100.00 | 0.00 |
| | | | glucose | | |
| 15 | 11.9253 grams | 51.55 | 100% of | 0.015 | 99.985 |
| | | | fructose | | |

### Example 8

To handle a 200 gallons per minute of 60% D.S. feed throughput; the typical industrial apparatus of SMB process is designed as four columns having each of 14 feet in I.D. and 27.5 feet in height. Each column loaded with 4125 cubic-ft, or, 30,855 gallons has total of 123,420 gallons resin stock. SMB requires 350 gallons per minute input rate of eluent water to retrieve 88% of fructose recovery in purity as 90% of fructose and 10% glucose. Direct comparison in between SMB process and current disclosure is based in terms of resin stock and eluent consumption under same throughput and feed composition. As indicated, the volume ratio of water to feed is 1.19, it means 238 gallons of eluent water is required based on 200 gallons throughput. The current disclosure has 68% water consumption compared to 350 gallons in traditional SBM process.

The volume ratio of feed input to bed volume is 0.258. The cycle time is 96 minutes in FIG. 3, which is 96 minimal time interval. The resin stock required for 96 minutes cycle time is calculated by 200 divided by 0.258 then times 96, which is equivalent to 74419 gallons to handle 200 gallons per minute feed throughput. In comparison to 123,420 gallons used up in SMB process, the resin stock calculated with said 123420 gallons is 60.3% based on alike feed throughput. Furthermore, the superior separation result demonstrated in previous examples is evidently relevant to this cycle time and is fundamental to calculate required resin stock to be employed by this disclosed apparatus and process.

1. A process for separating glucose, fructose, and oligos from a homogenous aqueous feed solution containing alike, said process comprising of:
(a) proceeding by a new mass transfer method containing at least one of following steps:
(i) Retain solid phase resin material in a bundled group of predetermined quantity of columns, each column having an inlet on top side and an outlet on another side with bottom meshed filter to contain equal amount of said material from being drained; such bundled group of columns performing like partially fluidized beds as a whole unit named being cell hereinafter; in each column retaining equal amount of resin solid material as plurality of columns installed in a said cell, wherein installed resin amount in each column is equivalent to mass transfer zone in chromatography; the liquid inlet of cell is from top and liquid outlet of cell is from bottom;
(ii) intermittently delivering predetermined amounts of mobile phase liquid material in portion as impulse input S-I dose dropping including aqueous feed solution, aqueous homogeneous mixture containing sugar components, and eluent water, to either promoting adsorption of dissolved components onto said resin material and meanwhile eluting adsorbed components from said resin;
(iii) intermittently and simultaneously supplying broad range pressurized inert gas to each cell top side following each delivery of said mobile phase dose to force prompt draining such mobile phase through said solid phase material to complete expected mass transfer equilibrium via bonding affinity difference among sugar components between two phases;
(iv) maintaining a closed vacuum environment on the other side of said solid phase material installed in said cell to maintain resin material in a semi-dry status; wherein said broad range pressurized inert gas being supplied from cell top and whereas vacuum being exerted from cell bottom;
(v) collecting most of treated mobile phase liquid material from the outlet of cell bottom;
(vi) defining total spent time of step (ii) through step (v) being minimal time interval; and
(b) an apparatus integrating multiple modules contained in a closed loop and each module functioning independently, wherein each module connected in sequence and yet coordinated as a whole unit; expansion of particular component in size disposed in a module and/or operating of multiple modules in parallel being deemed as part of the disclosed apparatus; and furthermore, such addition of increasing quantity of same module and module connected in sequence as plurality of modules connected in sequence operated in parallel format also being governed under this disclosed apparatus; such apparatus comprising at least one of following modules:
(i) Upstream Holding Tanks Module: having plurality of holding tanks disposed in an organized order setting inside an insulated warm water circulation jacket to maintain whole plurality in a selected temperature range; each said holding tank of whole plurality having an inlet liquid conduct extended outside upward of said jacket to receive liquid via a preferred mechanical device opened flipper, named as flipper 1 hereinafter disposed about bottom inside of said liquid conduct; each of said whole plurality holding tanks having an outlet liquid conduct extended outside downward of said jacket installed with another flipper, named as flipper 2 hereinafter disposed about top inside of said liquid conduct to hold the received liquid when flipper 2 being closed or to discharge liquid into following module when said flipper 2 being opened whereas said flipper 1 being closed; wherein driven force utilized for opening or closing a flipper via supplying broad pressure range of inert gas via its respective gas pipe disposed around each said holding tank top and bottom side;
(ii) Upstream Rotary Union Module: this preferred module having a rotational circular multiple valves body driven by a Servo-motor rotate to intermittently stopped and stepped forward a predetermined equal angle in a run around selected direction; having a plurality of preferred top side liquid transit storage reservoirs orderly installed at predetermined location to simultaneously receiving said predetermined volume of liquid transferred from particular holding tank of aforesaid upstream holding tanks module and having equal quantity of preferred bottom liquid conduct orderly disposed at corresponding location; soon receiving of all kind liquid in each said liquid transit storage reservoirs being satisfied, said valve body promptly stepping forward one rotation angle step, then to precisely transmitting said predetermined volume of liquid to next following module and waiting for another round of liquid throughput; at any time interval between stopped and rotating step forward of said valve body, all kinds of liquid original stored in each said upstream holding tanks module is simultaneously delivered through means of supplying broad pressure range of inert gas to push such liquid delivery from particular holding tank via opened flipper through this Upstream Rotary Module to the following module;
(iii) Separation Module: having a plurality of aforesaid cells organized in a similar order like said upstream holding tanks module being preferred set up; each cell comprising predetermined quantity of columns orderly disposed inside each cell; each column having an top side inlet and a bottom side outlet with meshed filter to contain equal amount of resin material from being drained; such plurality of cells disposed in an organized order setting inside an insulated warm water circulation jacket to maintain whole plurality of cells in a selected temperature range; each cell top having an inlet liquid conduct as temporary transit reservoir extended outside upward of said water jacket to receive particular liquid delivered from corresponding holding tank in said upstream holding tanks module through an opened flipper, named as flipper 3 hereinafter disposed around top inside of said liquid transit storage reservoir, through said upstream rotary union module and via a showerhead alike down below; such showerhead alike comprising of another preferred mechanical device flipper, named as flipper 4 hereinafter disposed inside in between bottom side of said temporary transit reservoir and top side of showerhead; via means of alternatively and simultaneously supplying of broad range pressurized inert gas through gas pipe connected in between said flipper 3 and flipper 4 of said temporary transit reservoir and another gas pipe disposed next to said temporary transit reservoir to intermittently dose dropping in parts of received liquid out of temporary transit reservoir resulting as impulse input S-I to promptly wet top portion and promptly sipping through resin bed to carry out expected mass transfer equilibrium;
each said cell bottom side being exposed to said closed vacuum environment containing all said transit liquid reservoirs with its widely open top means to withdrawing wet inert gas via its gas exit pipe through manifold alike to maintaining said resin in a semi-dry status, and to affiliating liquid draining via disposed funneled shape liquid conduct; via another opened mechanical flipper, names as flipper 65 hereinafter disposed inside bottom of said funnel conduct, into each underneath temporary liquid reservoir; having a gas pipe connected with same manifold next to said wet inert gas exit pipe means for supplying broad range pressurized inert gas via this manifold to shut off said flipper 65 soon said vacuum environment being shut off, so that pushing entire drained liquid into following module via another opened flipper, named as flipper 5 hereinafter disposed around top inside of said bottom liquid conduct, wherein said inert gas manifold being disposed underneath said closed vacuum environment and being extended outside downward of said insulated warm water circulation jacket;
(iv) Downstream Rotary Union Module: this preferred module having a rotational circular multiple valves body driven by a Servo-motor rotate to intermittently stopped and stepped forward a predetermined equal angle in a run around selected direction; having a plurality of preferred top side liquid transit storage reservoirs orderly installed at predetermined location to simultaneously receiving said drained liquid transferred from particular temporary liquid reservoir of aforesaid separation module and having equal quantity of preferred bottom liquid conduct orderly installed at corresponding location; soon receiving of all kind liquid in each said temporary liquid reservoirs being satisfied, said valve body promptly stepping forward one rotation angle step, then to precisely transmitting said entire volume of liquid to next assigned holding tank in following downstream holding tanks module and waiting for another round of liquid throughput; in event of steady state operation wherein valve body advance one rotation step means disclosed apparatus achieve one complete separation cycle;
(v) Downstream Holding Tanks Module: having plurality of holding tanks disposed in an organized order setting inside an insulated warm water circulation jacket to maintain whole plurality in a selected temperature range; each said holding tank of whole plurality having a top side inlet liquid conduct extended outside upward of said jacket means for freely receiving particular fluid via a preferred mechanical device opened flipper, named as flipper 6 disposed about top inside of said liquid conduct; wherein driven force utilized for opening or closing said flipper 6 via supplying broad range pressurized inert gas via its respective gas pipe disposed about next to said inlet liquid conduct; each of said whole plurality holding tanks having an outlet liquid conduct extended outside downward of said jacket means for discharging stored liquid as pure glucose Raffinate into assigned storage tank; means for discharging pure fructose as Product into another assigned storage tank; and means for transmitting in part of available liquid stored in respective holding tank in predetermined volume recycling back via each volumetric pump into each assigned holding tank in aforesaid upstream holding tanks module; having preferred liquid level sensor installed inside each holding tank inasmuch as maintaining predetermined liquid level of stored liquid within, means via such level sensor being to control delivering sufficient volume of predetermined composition of sugar mixture via its liquid conduct disposed on top side of each holding tank to maintaining such predetermined liquid level setting within respective said holding tank;
(vi) Inert Gas Supply Module means for focusing on setting up closed loop routing for supplying broad range pressurized inert gas inasmuch as incorporating with liquid fluid transmitting among said upstream holding tanks module, upstream rotary union module, separation module, downstream rotary union module, and downstream holding tanks module, wherein such inert gas module comprising closed vacuum environment loop, upstream broad range inert gas supplying loop, and downstream broad range inert gas supplying loop; and further setting up
(c) a differential set-up protocols employed between said resin and various kinds of liquids including a feed solution, an eluent water, and a plurality of recycled liquids for intermittently delivering into said apparatus; further arranging such differential protocols and
(d) a single stage recycle protocol employed onto said apparatus, via said new mass transfer method and through such combinations to retrieve all liquid streams including a raffinate stream of glucose enriched solution, a plurality of recycles streams, and a product stream of fructose enriched solution with steady characteristics in composition and concentration into respective holding tank in said downstream holding tanks module.

2. The process of claim 1 wherein said driven force utilized for closing said flipper 2 disposed around top inside of said liquid conduct disposed underneath each holding tank in upstream holding tank module via supplying broad pressure range of inert gas via its respective gas pipe is preferred medium range pressurized inert gas, wherein is set in between 55 psi and 70 psi to hold entire liquid weight.

3. The process of claim 1 wherein said driven force utilized for closing said flipper 1 disposed bottom inside of said liquid conduct of each holding tank in upstream holding tank module via supplying broad pressure range of inert gas via its respective gas pipe is preferred low range pressurized inert gas, wherein is set in between 40 psi and 55 psi.

4. The process of claim 1 wherein said driven force utilized for alternatively closing said flipper 3 and either closing or opening of said flipper 4 via supplying preferred broad pressure range of inert gas through respective gas pipe to carry out expected mass transfer equilibrium is preferred high range pressurized inert gas, wherein is set in between 70 psi and 90 psi.

5. The process of claim 1 wherein said driven force utilized for closing said flipper 65 disposed around bottom inside of said funneled liquid conduct of bottom portion of separation module via supplying broad pressure range of inert gas via its respective gas pipe is preferred low range pressurized inert gas, wherein is set in between 40 psi and 55 psi.

6. The process of claim 1 wherein said driven force utilized for closing said flipper 5 disposed around bottom inside of said liquid conduct underneath separation module via supplying broad pressure range of inert gas via its respective gas pipe is preferred medium range pressurized inert gas, wherein is set in between 55 psi and 70 psi.

7. The process of claim 1 wherein said closed vacuum environment for maintaining solid resin material in semi-dry status, wherein preferred vacuum level is set in between 15 in-Hg to 27 in-Hg.

8. The process of claim 1 wherein said driven force utilized for closing said flipper 6 disposed around top inside of said liquid conduct of each holding tank in downstream holding tank module via supplying broad pressure range of inert gas via its respective gas pipe is preferred high range pressurized inert gas, wherein is between 70 psi and 90 psi.

9. The process of claim 1 wherein said temperature range of fresh dry inert gas maintained slightly above all kind of liquid solutions temperature range means to prevent microbiological growth, wherein is between 60 and 80 Celsius degrees; whereas said water temperature range maintained for insulated warm water circulation jacket of the upstream holding tanks module, separation module, and downstream holding tanks module for preventing microbiological growth and reducing viscosity for transiting liquid is between 55 and 70 Celsius degrees.

10. The process of claim 9 wherein said water temperature maintaining for such plurality of holding tanks disposed in said upstream holding tanks in a particular pattern inside said insulated warm water circulation jacket having a manifold alike inlet and manifold alike outlet for water circulation to maintain whole plurality of holding tanks in a selected temperature range, wherein each holding tank having a top liquid inlet extended outside upward of said water circulation jacket and bottom liquid outlet extended outside downward of said jacket.

11. The process of claim 9 wherein said water temperature maintaining for such plurality of holding tanks disposed in said downstream holding tanks module in a particular pattern inside said insulated warm water circulation jacket having a manifold alike inlet and manifold alike outlet for water circulation to maintain whole plurality of holding tanks in a selected temperature range, wherein each holding tank having a top liquid inlet extended outside upward of said water circulation jacket and bottom liquid outlet extended outside downward of said jacket.

12. The process of claim 9 wherein said water temperature maintaining for such plurality of cell disposed in said separation module in a particular pattern inside insulated water circulation jacket, such jacket has plurality of baffle plates vertically installed to confine each cell inside a predetermined compartment, such plate alternatively arranged to allow warm water freely enter from one top inlet and exit next top outlet into next cell compartment; so that warm water freely entered via a manifold alike of said insulated water circulation jacket, freely circulating through first cell confined in said separation module, then continue entering 2^{nd} cell, 3^{rd} cell until water stream pass through all confined cell compartments, then exit said jacket through a manifold alike to maintain all disposed cells in an predetermined temperature range.

13. The process of claim 1 said broad range pressurized inert gas, wherein preferred inert gas used for this disclosed apparatus is nitrogen, carbon dioxide, argon or mixtures of gas in portions to reduce oxygen oxidation with resin from hindering long term separation efficiency.

14. The process of claim 1 wherein said resin filled in each column disposed orderly in each cell of the apparatus is a strongly acidic cation exchanger of one type of the alkaline-earth metals base.

15. The process of claim 14 wherein said resin filled in each cell of the apparatus is calcium base strongly acidic cation exchanger.

16. The process of claim 1 wherein said eluent water is dirt free de-ionized water.

17. The process of claim 1 wherein said impulse input S-I as dose dropping in new mass transfer method means the volume of all mobile phases including feed solution, eluent water and recycled streams liquid phase being subdivided into several predetermined doses and simultaneously delivered within a shortest time domain into all cells during each said minimal time interval is spent. Such liquid being delivered via described step (iii) and step (iv) to push off such delivered liquid to form a partially wetted region for instantaneous and heterogeneous mass transfer contact to materialize equilibrium status between the drained liquid collected in step (v) and said resin material installed in respective cell.

18. The process of claim 1 wherein said mass transfer zone is the predetermined of equal amount of resin installed in each said column is completely saturated with predetermined input volume of feed solution and such installed resin being maintaining in semi-dry status.

19. The process of claim 18 wherein said maintaining resin in semi-dry status in said new mass transfer method through means of supplying pressurized inert gas from top side of cell and exerting vacuum from cell bottom is to remove eluent water filled among resin matrix within short possible time period.

20. The process of claim 1 said inert gas supply module comprising following:
1) Closed vacuum environment loop: as aforementioned of each cell bottom containing all transit liquid reservoirs orderly disposed within said separation module being exposed to said closed vacuum environment to affiliating receiving dropped dose of liquid draining, meanwhile to extracting water mist enriched wet inert gas to maintaining said resin installed in each cell of separation module in a semi-dry status through means extracting wet inert gas to dry inert gas via driving force exerted form central vacuum pump through its manifold alike via a mist separation to recover water moisture from wet inert gas for recycling; meanwhile to create a heterogeneous contact as said dropped dose of liquid promptly sipping through stationary resin particles to meet criterion of said new mass transfer method; the whole time, such dry inert gas exiting mist separator being combined with pressurized dry air and deployed through an inert gas generator to obtain fresh dry inert gas and stored in a steel tank vessel maintaining preferred broad range of pressure level inert gas ready for deploying back to following modules;
2) Upstream broad range inert gas supplying loop: means for upstream holding tanks module and all cells top region in separation module; via supplying said medium range pressurized inert gas out of said tank vessel via its gas line routing wherein through manifold alike disposed below said upstream holding tanks module to simultaneously deploying via respective gas pipe connected to bottom side liquid conduct of each holding tank, whereas low range pressurized inert gas supplying via its gas line routing wherein through manifold alike disposed above said upstream holding tanks module to simultaneously deploying via each gas pipe disposed next to liquid conduct on top side of each holding tank being shut off; so that mechanical device said flipper 1 disposed around bottom side of said top side liquid conduct being opened to allow predetermined liquid volume transferred from assigned holding tank in said downstream holding tanks module via each said volumetric pump freely passing through top side liquid conduct, whereas mechanical device said flipper 2 disposed around bottom side of each holding tank being pushed upward to block liquid from flowing downward to temporarily store delivered liquid into each said holding tank disposed in said upstream holding tanks module;
as aforesaid operation being concluded, said medium range pressurized inert gas routing being promptly shut off; meanwhile simultaneously supplying said low range pressurized inert gas routing being turned on, together yet separately supplying high range pressurized inert gas via its gas line routing being turned on, wherein such high range pressurized inert gas routing through its gas line out of said vessel tank through manifold alike disposed above said separation module to simultaneously deploying via each gas pipe disposed around next to liquid conduct having a mechanical device said flipper 3 disposed around top inside, wherein both gas pipe and liquid conduct being disposed on top side of separation module; via such operation resulting said flipper 1 disposed around bottom side of liquid conduct of each upstream holding tank and said flipper 3 disposed on top inside of liquid conduct disposed on top of separation module being both closed, whereas said flipper 2 disposed around bottom side of each holding tank being opened allowing entire liquid been stored within freely transferring from each said upstream holding tank via its bottom side liquid conduct into respective said transit reservoir orderly disposed in aforesaid upstream rotary union module; said rotary valve body disposed in said upstream rotary union module promptly advancing one rotation step;
soon said upstream rotary union valve body being stopped, said low pressure inert gas routing disposed top side of holding tanks module and high pressure inert gas routing disposed on top side of separation module both being promptly shut off; meanwhile simultaneously out of tank vessel to resume supplying said medium range pressurized inert gas routing together with yet separately supplying said high range pressurized inert gas, named as warm high range pressurized inert gas routing hereinafter out of said vessel tank through said inline gas warmer via its gas line routing through manifold alike disposed below aforesaid high range pressurized inert gas via each pipe disposed next to said liquid conduct disposed on top of separation module to supply of high pressurized inert gas, so that such operation resulting to simultaneously close said flipper 2 and said flipper 4, resulting simultaneously to transmit entire liquid stored in respective transit reservoir of said valve body via opened flipper 3 into respective temporary transit reservoir located at top of said separation module;
soon aforesaid operation is completed, said high pressure inert gas routing is promptly turned on in a predetermined short time duration to close said flipper 3; whereas said warm high range pressurized inert gas routing meantime being shut off, resulting liquid stored inside respective temporary transit reservoir located at top of said separation module to simultaneously promptly passing freely through said flipper 4 to drop in parts of stored liquid during said very short time period to wet top portion of installed solid resin; then, immediately soon warm high pressure inert gas supply routing being turned on and whereas high range pressurized inert gas routing meanwhile being shut off, such operation means for pushing back said flipper 4 to stop liquid from dropping; means for pushing dropped dose of all kind of liquids through said resin contained in each cell to complete expected aforesaid mass transfer equilibrium between two phases; alternatively repeating operation between on and or off supplying of said two types of high range pressurized inert gas routing with dividing stored liquid in temporary transit reservoir located at top of said separation module in predetermined liquid doses means to proceed differential set up between solid and liquid phase;
3) Downstream broad range inert gas supplying loop: means for all cells bottom region in separation module and downstream holding tanks module; during duration of exerted vacuum environment via said vacuum exit pipe onto bottom region of said separation module in order to continuously and simultaneously drain dropped doses of liquid into respective underneath liquid reservoir; meanwhile, medium range pressurized inert gas routing deployed out of said tank vessel being turned on, via its gas line through manifold alike disposed underneath said separation module via each gas pipe connected to each liquid conduct disposed at bottom of said holding tank, such liquid conduct having preferred mechanical device said flipper 5 disposed around top inside; such operation resulting to push upward said flipper 5 via supplying medium pressure range inert gas to hold drained liquid stored in respective said liquid reservoir;
soon as liquid draining being completed, both vacuum environment and said medium range pressurized inert gas being promptly shut off; then, low range pressurized inert gas routing supplied via its pipe disposed next to said vacuum exit pipe in same manifold and high pressure range inert gas routing supplied via its pipeline through manifold alike disposed above said downstream holding tanks module being promptly turned on, such operation resulting both said flipper 65 disposed inside of said funneled liquid conduct and said flipper 6 disposed inside liquid conduct located on top of each liquid transit holding tank in said downstream holding tanks module being closed, whereas said flipper 5 disposed inside bottom liquid conduct of respective liquid reservoir being opened to allow entire stored liquid simultaneously freely pushing into each underneath liquid transit storage reservoir in said downstream rotatory union module; said valve body in downstream rotary union module promptly advancing one rotation step; soon after multiple valve body being stopped, said medium pressure range inert gas via its routing promptly resume supplying; such operation resulting to close flipper 5 to push stored liquid in each liquid reservoir through opened said flipper 6 into each assigned holding tank in said downstream holding tanks module.

21. The process of claim 20 wherein said inert gas supply module being sub-module integrated with said separation module to incorporate with aforesaid other modules through which during duration of each spent time interval in steady state operation, all kind of liquid solutions simultaneously distributed entire available liquid solution from respective holding tank disposed orderly in upstream holding tanks module through each transit reservoir disposed orderly in upstream rotary union module, and simultaneously intermittently transmitted into respective cell body in separation module to carry out mass transfer equilibrium; drained and collected liquid in each transit reservoir transferred via each transit reservoir disposed orderly in downstream rotary union module into each holding tank disposed orderly in downstream holding tanks module. Through such organized liquid transmitting in a repeated manner via inert gas supplying module incorporated with disclosed apparatus comprising multiple modules connected in sequence in a close loop to continuously achieve separation of glucose and fructose mixture.

22. The process of claim 1 of said operating of multiple modules in parallel being deemed as part of the disclosed apparatus, wherein means for disposing multiple separation modules simultaneously operated in parallel during duration of each spent time interval in steady state operation; whereas predetermined volume of all kind of liquids being transported via other single module connected in sequence from each holding tank in upstream holding tanks module via upstream rotary union module to satisfied designated throughput of multiple separation modules simultaneously operated in parallel disposed in this disclosed apparatus.

23. The process of claim 1 wherein said differential set-up protocol employed onto said apparatus comprise the following methods:
(a) determining optimal full-strength bonding capacity of said resin with a prefixed feed throughput and filling such resin amount into a said column;
(b) proceeding start-up test through said new mass transfer method by intermittently delivering a predetermined volume of feed solution then following by an eluent to produce a characteristic profile; and
(i) breaking down said profile according to the collected samples in part as order been collected as a plurality of recycled liquid mixture for further test;
(ii) producing a characteristic profile by intermittently delivering said recycled liquid mixtures in order as gathered, a feed solution delivering after a sugar mixture having glucose content slightly higher than that in feed solution and prior to a sugar mixture having glucose content slightly lower than that in feed solution, then, remaining recycled liquids in order, following by an eluent then by a liquid mixture first been collected from said profile;
(iii) breaking down said profile from step (ii) according to the collected samples in part as order been collected to predetermined sugar mixtures as a plurality of recycled liquids for further test;
(iv) repeating step (ii) and (iii) until a steady profile been obtained, meaning the concentration and composition of glucose and fructose of all liquid mixtures remaining steady through further testing to conclude said start-up test; and
(c) proceeding steady-state test through said new mass transfer method by intermittently delivering a predetermined volume of said various kinds of liquids having been arranged in a particular order, wherein all liquids including a feed solution, an eluent, and a plurality of recycled streams from previous start-up test;
(i) breaking down each required partial time according to the collected samples in part as order been collected for each respective delivered liquid and producing a characteristic profile, wherein said profile including in part of a raffinate of glucose enriched solution, a plurality of recycled liquid mixtures in particular order, and a product of fructose enriched solution expanding a plurality of recycled liquids by replacing each retrieved raffinate and product with a liquid mixture having particular composition and finite concentration respectively;
(ii) recording respective composition and concentration of whole spectrum of expanded recycled liquids;
(iii) proceeding further test by intermittently delivering the expanded recycled liquid mixtures from step (ii) in order as gathered, a feed solution delivering after a sugar mixture having glucose content slightly higher than that in feed solution and prior to a sugar mixture having glucose content slightly lower than that in feed solution, then, remaining recycled liquids in order, following by an eluent then by a liquid mixture first been collected from said profile;
(iv) recording the partial time required for respective delivered liquid for this particular profile obtained from step (iii), wherein said profile including in part of a raffinate of glucose enriched solution, a plurality of recycled liquid mixtures in particular order, and a product of fructose enriched solution;
(v) repeating step (i) through (iv) if the retrieved raffinate and product failing to satisfy a predetermined purity and concentration of a raffinate and a product; and only recording respective composition and concentration as expanded whole spectrum of recycled liquids characteristics if satisfied result is achieved means for following usage; and
(d) dividing each said partial time required for respective delivered liquid of said particular profile obtained from step (v) of step (c) by said minimal time interval to obtain the number of dose dropping as the particular range of zone for corresponding liquid inputting in said apparatus;
(e) dividing the volume of such liquid by the said number of dose dropping to obtain the partial volume required for each dropping;
(f) further dividing both said amount of resin obtained in step (a) and said partial volume by a pre-selected number that corresponding to a group of columns disposed in said single cell among group of cells to simultaneously receive the dose dropping volume for as the particular range of zone for corresponding liquid;
(g) allocating all cells with each respective liquid as the range of a particular zone;
(h) sequentially arranging all zones in the same order for all kinds of delivered liquids in an endless circular format in said apparatus; and further
(i) sequentially preparing predetermined volume of whole spectrum of recycled liquids recorded in step (v) of step (c) into respective holding tank in said downstream holding tanks module for supporting liquid distribution as said closed loop via said upstream holding tanks module, upstream rotary union module, separation module, downstream rotary union module, then back to downstream holding tanks module, affiliating via driving force of pressurized inert gas supply module.

24. The process of claim 23 wherein said an eluent is dirt free de-ionized water.

25. The method of claim 23 wherein said in step (ii) of step (c) for expanding a plurality of recycled liquids by replacing the retrieved raffinate and product with a mixture having respective composition as retrieved raffinate and product at an elevated concentration in between range of 40% to 60% of dry solid content.

26. The method of claim 23 wherein said pre-selected number in step (f) is a finite whole numbers greater than one.

27. The method of claim 23 wherein said a raffinate is a pure glucose in a finite concentration, a plurality of recycled liquids having steady characteristics in sugar composition and finite concentration, and a product is a pure fructose in a finite concentration.

28. The process of claim 1 wherein said single stage recycle protocol employed onto said apparatus through said new mass transfer method and differential set-up protocols between two phases to simultaneously feeding and elution for simultaneously retrieving streams of a raffinate, a plurality of recycled mixtures, and a product, in which comprising methods of:
(a) through means of said close loop of liquid delivery first via downstream holding tanks module through upstream holding tanks module affiliated with pressurized inert gas supply module, and means of rotation and positioning mechanism in said upstream rotary union module, completing mass transfer equilibrium in separation module then back to downstream rotary union module, said apparatus completing start-up step procedures containing following:
(i) a cell containing plurality of orderly disposed columns initially located at first position among all cells of said separation module receiving a predetermined volume of liquid delivery and remaining cells receiving no liquid; wherein delivering a predetermined volume of said various kinds of liquids having been arranged in a particular sequential order among all kinds of recycling streams, a feed solution, and another plurality of recycling stream arranged in a particular order, then an eluent, and lastly inert gas; wherein all above said liquids being transmitting, affiliating with supply of broad range of pressurized inert gas, in orderly sequence simultaneously from particular holding tank from downstream holding tanks module into particular holding tank in upstream holding tanks module and through particular transit reservoir in said upstream rotary inion module; and further wherein valve body in said upstream rotary union advance one rotation step through means of rotation mechanism prior transmitting received liquid into cells in said separation module;
(ii) intermittently deliver through means of alternated supplying between two separated broad range of pressurized inert gas routings following delivery of various liquids in dose of predetermined volume to force draining of dose dropped liquid promptly sipping through said resin to complete expected mass transfer contact equilibrium between two phases;
(iii) maintain a closed vacuum environment to drain the individual liquid solution into respective underneath temporary reservoir and to maintain resin in a semi-dry status;
(iv) intermittently collecting of all kind of drained liquids in each temporary reservoir and transmitting collected liquid into downstream rotary union via means of broad range of pressurized inert gas supply routing; valve body disposed in downstream rotary union advance one rotation step through means of rotation mechanism in predetermined rotating direction, then, via means of broad range of pressurized inert gas supply routing to push entire liquid simultaneously into each assigned holding tanks in downstream holding tanks module;
(v) Repeating repeatedly step (i) through step (iv) for initially located at first position of said separation module, then covering first and second cell in separation module simultaneously receiving liquid until transit reservoir disposed first receiving liquid disposed in upstream rotary union module and first receiving liquid of transit reservoir disposed in downstream rotary union module return to its initial position to complete one revolution, so that, start-up operation can be concluded, wherein retrieved all kinds of liquids during start-up operation as water for recycling, water with low D.S. glucose solution for other usage, all kind of recycle streams been stored in particular order; except the solution collected being glucose Raffinate and the solution being fructose Product; retaining all kind of sugar mixtures except Raffinate and Product from each assigned holding tank in said downstream holding tanks module for recycling via means of transmitting into each corresponding holding tank in said upstream holding tanks module; and further
(b) steady state operation containing following simultaneous and repeatedly repeated procedures during duration of each spent time interval:
(i) through means of aforesaid liquid delivery mode affiliating with broad range of pressurized inert gas, a predetermined volume of various kinds of liquids having been arranged in a particular order among all kinds of recycling streams, a feed solution, and another plurality of recycling stream arranged in a particular order, an eluent, and a pressurized inert gas; all above said liquids being transmitted simultaneously entire available liquid volume from respective holding tanks disposed in said upstream holding tanks module via means of broad range of pressurized inert gas supply routing forcing into respective transit reservoir in said upstream rotary union module; said valve body advance one rotation step through means of rotation mechanism in predetermined rotating direction, then via said liquid delivery mode transmitting affiliated with broad range of pressurized inert gas routing into each underneath cell's top-inlet of said separation module;
(ii) intermittently deliver through means of alternated supplying between two separated broad range of pressurized inert gas routings following delivery of various liquids in dose of predetermined volume to force draining of dose dropped liquid promptly sipping through said resin to complete expected mass transfer contact equilibrium between two phases;
(iii) maintaining a closed vacuum environment to continuous drain the individual liquid solution into respective underneath temporary reservoir and to maintain resin in a semi-dry status;
(iv) collecting all kind of drained liquids in each temporary reservoir and transmitting collected liquid into downstream rotary union via means of broad range of pressurized inert gas supply routing; valve body disposed in downstream rotary union advance one rotation step through means of rotation mechanism in predetermined rotating direction, then, via means of broad range of pressurized inert gas supply routing to push entire liquid simultaneously into each assigned holding tanks in downstream holding tanks module; transmitting all kind of sugar mixtures except glucose of Raffinate and fructose of Product for recycling via each assigned holding tank in downstream holding tanks module via means of respective liquid routing back to each corresponding holding tank in said upstream holding tanks module.

29. The method of claim 28 wherein said a raffinate stream is a pure glucose in a finite concentration, a plurality of recycled streams having steady characteristics in sugar composition and finite concentration, and a product stream is a pure fructose in a finite concentration.

30. The method of claim 28 wherein said providing broad range of pressurized inert gas via its routing having pressure rage in between 40 psi and 90 psi, and wherein preferred low range inert gas pressure is set in between 40 psi and 55 psi, wherein preferred medium range inert gas pressure is set in between 55 psi and 70 psi, and further wherein preferred high range inert gas pressure is set in between 75 psi and 90 psi.

31. The process of claim 28 wherein said preferred inert gas is nitrogen, carbon dioxide, argon or mixtures of gas in portions to reduce oxygen oxidation with resin from hindering long term separation efficiency.

32. The process of claim 28 wherein said closed vacuum environment for maintaining solid resin material in semi-dry status, vacuum level is between 15 in-Hg to 27 in-Hg.

33. The process of claim 28 wherein said an eluent is dirt free de-ionized water.
